(19) United States
(12) Patent Application Publication
(10) Pub. No.: US 2026/0082192 A1
(43) Pub. Date: Mar. 19, 2026

(54) EXCHANGING MESSAGES BETWEEN A DEVICE AND A READER

(71) Applicant: Samsung Electronics Co., Ltd., Suwon-si (KR)

(72) Inventor: Jeongho Jeon, San Jose, CA (US)

(21) Appl. No.: 19/316,651

(22) Filed: Sep. 2, 2025

Related U.S. Application Data
(60) Provisional application No. 63/696,811, filed on Sep. 19, 2024.
(60) Provisional application No. 63/718,497, filed on Nov. 8, 2024.
(60) Provisional application No. 63/777,493, filed on Mar. 25, 2025.

(51) Int. Cl. H04W 4/70; H04W 68/00; H04W 74/0833; H04W 84/18

(52) U.S. Cl. CPC H04W 4/70; H04W 68/005; H04W 74/0833; H04W 84/18

(57) ABSTRACT

Apparatuses and methods for exchanging messages between a device and a reader. A method includes receiving a first physical reader-to-device channel (PRDCH) providing an Ambient Internet of Things (A-IoT) paging message initiating device identification, determining, based on reception of the A-IoT paging message, an access occasion from a total number of access occasions via random selection, and receiving a second PRDCH providing an access trigger message triggering a set of access occasions from the total number of access occasions. The method further includes transmitting a first physical device-to-reader channel (PDRCH) providing a random identifier (ID) message including an ID in the determined access occasion, receiving a third PRDCH providing a random ID response message that confirms successful reception of one or more random ID messages and provides device to reader (D2R) scheduling information, and transmitting a second PDRCH providing a D2R message based on reception of the third PRDCH.

### CROSS-REFERENCE TO RELATED AND CLAIM OF PRIORITY

The present application claims priority under 35 U.S.C. § 119 (e) to U.S. Provisional Patent Application No. 63/696,811 filed on Sep. 19, 2024; U.S. Provisional Patent Application No. 63/718,497 filed on Nov. 8, 2024; and U.S. Provisional Patent Application No. 63/777,493 filed on Mar. 25, 2025, which are hereby incorporated by reference in their entirety.

### TECHNICAL FIELD

The present disclosure relates generally to wireless communication systems and, more specifically, the present disclosure is related to apparatuses and methods for exchanging messages between a device and a reader.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to exchanging messages between a device and a reader.

In one embodiment, a method for an Ambient Internet of Things (A-IoT) device to communicate with a reader is provided. The method includes receiving a first physical reader-to-device channel (PRDCH) providing an A-IoT paging message initiating device identification. The A-IoT paging message indicates a total number of access occasions, a number of time domain resources of the access occasions, and via a bitmap, a set of allowed small frequency shift factors. The method further includes determining, based on reception of the A-IoT paging message, an access occasion from the total number of access occasions via random selection, receiving a second PRDCH providing an access trigger message triggering a set of access occasions from the total number of access occasions, transmitting a first physical device-to-reader channel (PDRCH) providing a random identifier (ID) message including a 16-bit random number as an ID in the determined access occasion, and receiving a third PRDCH providing a random ID response message. The random ID response message confirms successful reception of one or more random ID messages. The random ID response message provides device to reader (D2R) scheduling information including information related to D2R chip length. The method further includes transmitting a second PDRCH providing a D2R message based on reception of the third PRDCH.

In another embodiment, an A-IoT device is provided. The A-IoT device includes a transceiver configured to receive a first PRDCH providing an A-IoT paging message initiating device identification. The A-IoT paging message indicates a total number of access occasions, a number of time domain resources of the access occasions, and via a bitmap, a set of allowed small frequency shift factors. The A-IoT device further includes processing circuitry operably coupled with the transceiver. The processing circuitry is configured to determine, based on reception of the A-IoT paging message, an access occasion from the total number of access occasions via random selection. The transceiver is further configured to receive a second PRDCH providing an access trigger message triggering a set of access occasions from the total number of access occasions, transmit a first PDRCH providing a random ID message including a 16-bit random number as an ID in the determined access occasion, and receive a third PRDCH providing a random ID response message. The random ID response message confirms successful reception of one or more random ID messages. The random ID response message provides device to reader (D2R) scheduling information including information related to D2R chip length. The transceiver is further configured to transmit a second PDRCH providing a D2R message based on reception of the third PRDCH.

In yet another embodiment, a reader is provided. The reader includes a transceiver configured to transmit, to an A-IoT device, a first PRDCH providing an A-IoT paging message initiating device identification. The A-IoT paging message indicates a total number of access occasions, a number of time domain resources of the access occasions, and via a bitmap, a set of allowed small frequency shift factors. The reader further includes a processor operably coupled with the transceiver. The processor is configured to determine, based on transmission of the A-IoT paging message, an access occasion from the total number of access occasions via random selection. The transceiver is further configured to transmit a second PRDCH providing an access trigger message triggering a set of access occasions from the total number of access occasions, receive a first PDRCH providing a random ID message including a 16-bit random number as an ID in the determined access occasion, and transmit a third PRDCH providing a random ID response message. The random ID response message confirms successful reception of one or more random ID messages. The random ID response message provides D2R scheduling information including information related to D2R chip length. The transceiver is further configured to receive a second PDRCH providing a D2R message based on transmission of the third PRDCH.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure using orthogonal frequency division multiplexing (OFDM) according to embodiments of the present disclosure;

FIG. 6 illustrates an example of a receiver structure using OFDM according to embodiments of the present disclosure;

FIG. 7 illustrates an example encoding structure for a downlink control information (DCI) format according to embodiments of the present disclosure;

FIG. 8 illustrates an example decoding structure for a downlink control information (DCI) format according to embodiments of the present disclosure;

FIG. 9 illustrates an example type-1 backscatter structure for IoT devices according to embodiments of the present disclosure;

FIG. 10 illustrates an example impedance matching circuit according to embodiments of the present disclosure;

FIG. 11 illustrates an example type-2a backscatter structure for IoT devices according to embodiments of the present disclosure;

FIG. 12 illustrates an example type-2a backscatter structure for IoT devices according to embodiments of the present disclosure;

FIG. 13 illustrates an example type-2a backscatter structure for IoT devices according to embodiments of the present disclosure;

FIG. 14 illustrates an example type-2b active structure for IoT devices according to embodiments of the present disclosure;

FIG. 15 illustrates an example type-2b active structure for IoT devices according to embodiments of the present disclosure;

FIG. 16 illustrates an example type-2b active structure for IoT devices according to embodiments of the present disclosure;

FIG. 17 illustrates an example system for device to reader (D2R)/reader to device (R2D) transmission involving an intermediate node according to embodiments of the present disclosure;

FIG. 18 illustrates an example signal structure for ambient IoT (A-IoT) systems according to embodiments of the present disclosure;

FIG. 19 illustrates example signal structures for A-IoT systems according to embodiments of the present disclosure;

FIG. 20 illustrates a timeline for an example sequential identification process according to embodiments of the present disclosure;

FIG. 21 illustrates a flowchart of an example device procedure for performing random access according to embodiments of the present disclosure;

FIG. 22 illustrates a timeline of an example multiplexed identification process according to embodiments of the present disclosure;

FIG. 23 illustrates a timeline of an example Msg 2 group-acknowledgement (ACK) transmission according to embodiments of the present disclosure;

FIG. 24 illustrates a flowchart of an example device procedure for receiving a physical reader to device (R2D) channel (PRDCH) according to embodiments of the present disclosure;

FIG. 25 illustrates an example PRDCH according to embodiments of the present disclosure;

FIG. 26 illustrates a timeline of example burst Msg 2 transmissions according to embodiments of the present disclosure;

FIG. 27 illustrates a flowchart of an example device procedure for receiving a PRDCH according to embodiments of the present disclosure;

FIG. 28 illustrates a flowchart of an example device procedure for receiving a PRDCH and transmitting a PRDCH according to embodiments of the present disclosure;

FIG. 29 illustrates a flowchart of an example device procedure for determining PDRCH transmission timing according to embodiments of the present disclosure;

FIG. 30 illustrates an example preamble signal structure according to embodiments of the present disclosure;

FIG. 31 illustrates a flowchart of an example device procedure for transmitting a PDRCH according to embodiments of the present disclosure;

FIGS. 32A and 32B illustrate timelines of example Msg 2 group-ACK transmissions according to embodiments of the present disclosure;

FIG. 33 illustrates a flowchart of an example device procedure for receiving a PRDCH according to embodiments of the present disclosure;

FIG. 34 illustrates an example PRDCH according to embodiments of the present disclosure;

FIGS. 35A and 35B illustrate timelines of example burst Msg 2 transmissions according to embodiments of the present disclosure;

FIG. 36 illustrates a flowchart of an example device procedure for receiving a PRDCH according to embodiments of the present disclosure;

FIG. 37 illustrates a flowchart of an example device procedure for receiving a PRDCH and transmitting a PRDCH according to embodiments of the present disclosure;

FIG. 38 illustrates a timeline for example scheduling multiple D2R transmissions according to embodiments of the present disclosure;

FIG. 39 illustrates a timeline of example reception timing for a Msg2 corresponding to multiple Msg 1 according to embodiments of the present disclosure;

FIG. 40 illustrates a timeline of example reception timing for a Msg2 corresponding to a Msg1 according to embodiments of the present disclosure; and

FIG. 41 illustrates an example PRDCH according to embodiments of the present disclosure.

### DETAILED DESCRIPTION

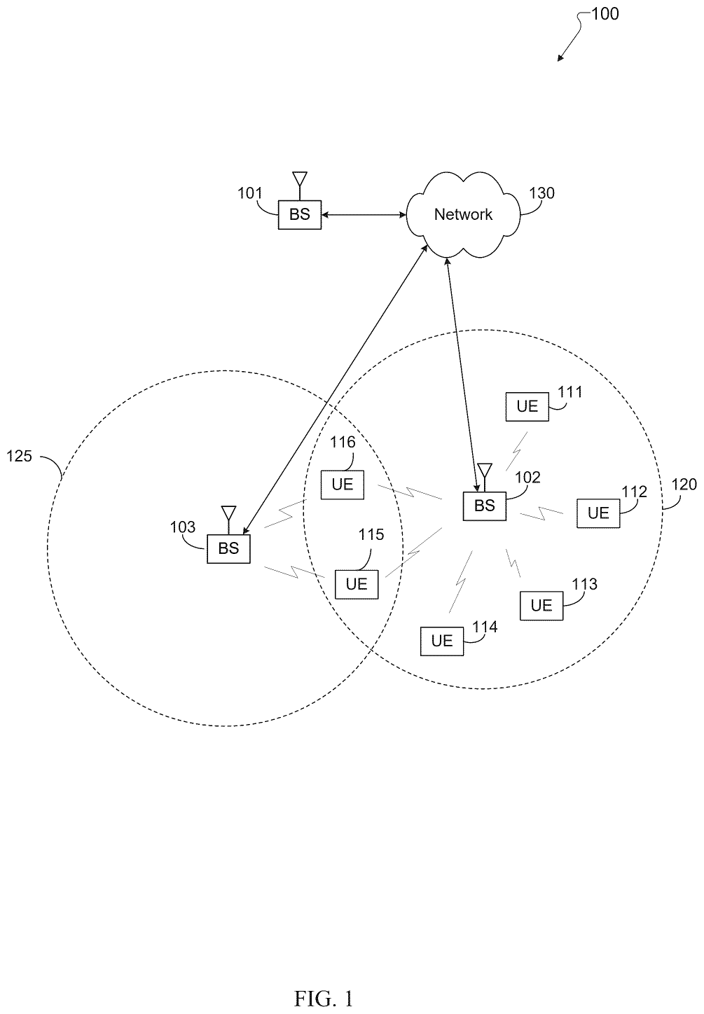

FIGS. 1-41, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [REF 1] 3GPP TS 38.211 v18.3.0, “NR; Physical channels and modulation;” [REF 2] 3GPP TS 38.212 v18.3.0, “NR; Multiplexing and channel coding;” [REF 3] 3GPP TS 38.213 v18.3.0, “NR; Physical layer procedures for control;” [REF 4] 3GPP TS 38.214 v18.3.0, “NR; Physical layer procedures for data;” [REF 5] 3GPP TS 38.331 v18.1.0, “NR; Radio Resource Control (RRC) protocol specification;” and [REF 6] 3GPP TS 38.321 v18.1.0, “NR; Medium Access Control (MAC) protocol specification.”

FIGS. 1-3 below describe various embodiments implemented in wireless communications systems and with the use of OFDM or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof to support exchanging messages between a device and a reader. In certain embodiments, one or more of the gNBs 101-103 include circuitry, programing, or a combination thereof to support exchanging messages between a device and a reader.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

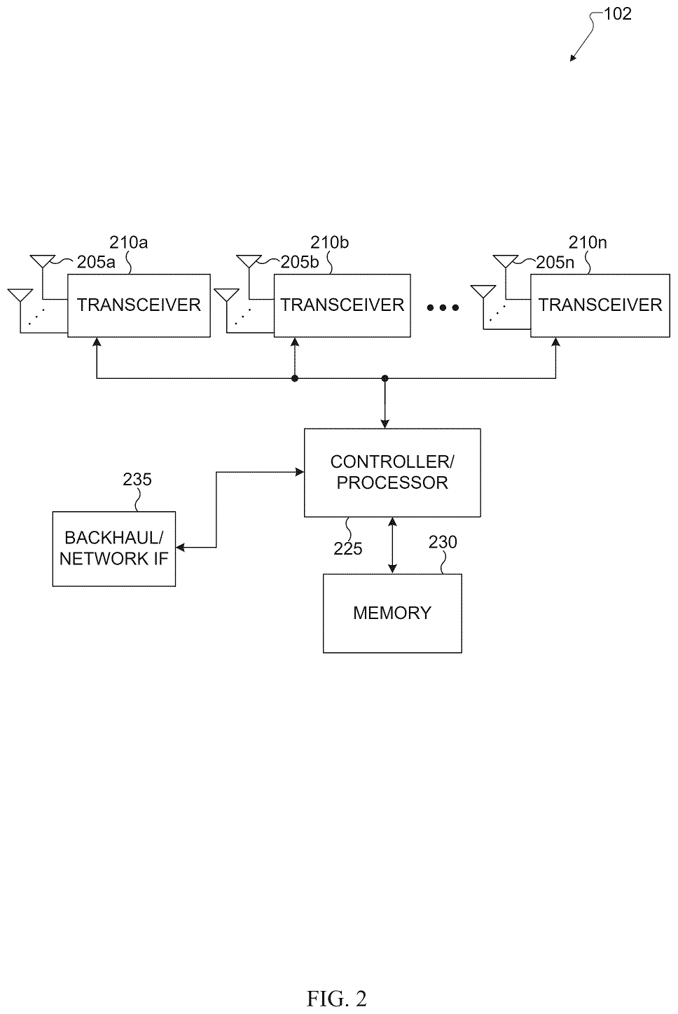

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as exchanging messages between a device and a reader. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

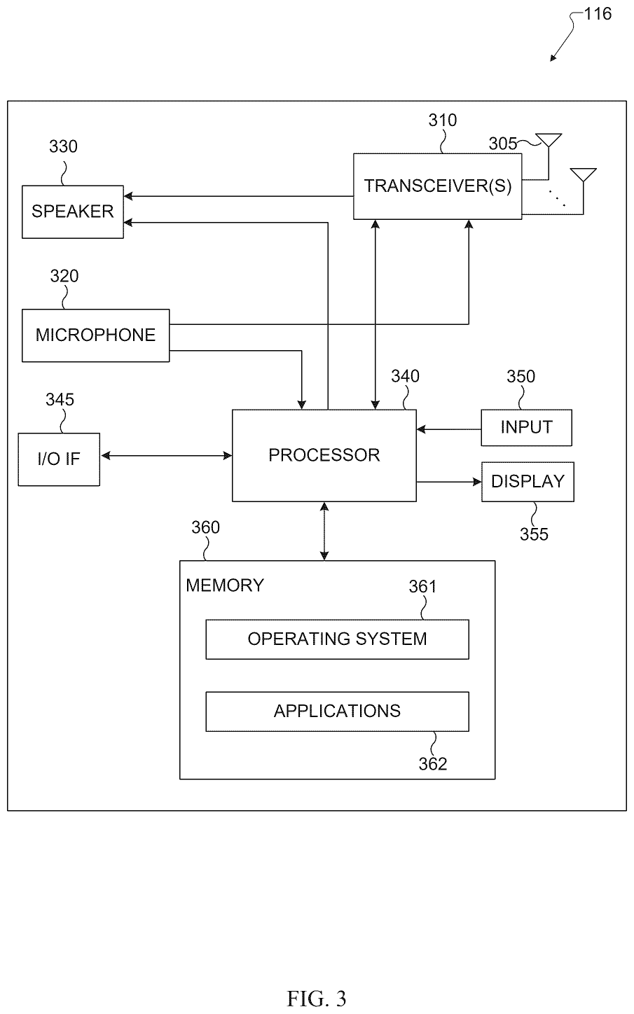

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to support exchanging messages between a device and a reader as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include volatile memory such as a random-access memory (RAM), and another part of the memory 360 could include non-volatile memory a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

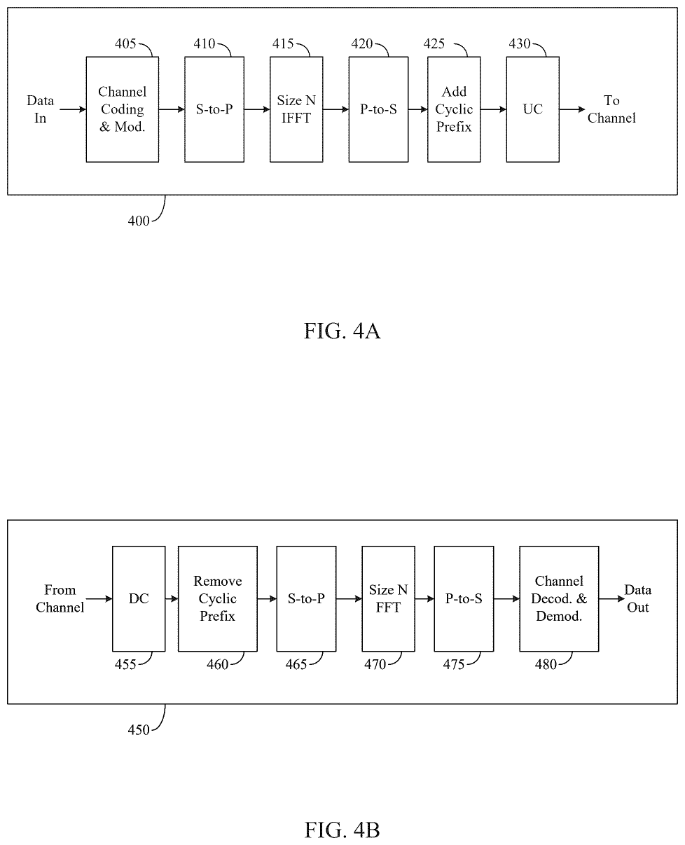

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for exchanging messages between a device and a reader as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

Internet of things (IoT) devices include ambient-power-enabled IoT (A-IoT) devices, which are ultra-low-complexity devices with very small form factor and low-cost design that operate without a common battery that can be manually replaced or recharged. Instead, A-IoT devices can be battery-less or with a small battery (such as a small capacitor) that operate based on energy harvesting from RF waveforms or other ambient energy sources. Regarding the limited size and complexity required by practical applications for battery-less devices with no energy storage capability or devices with limited energy storage that do not need to be replaced or recharged manually, the output power of energy harvester is typically from 1 μW to a few hundreds of μW.

In various embodiments throughout the disclosure, a UE (e.g., the UE 116) or a device may be referred to as an A-IoT device or an A-IoT UE based on energy harvesting with ultra-low complexity and power consumption and for low-end IoT applications. For example, the UE may have limited (or no) energy storage or battery capability (e.g., a capacitor), such as an energy storage unit for amplification of receptions at the UE or transmission by the UE, or for other UE operations, such as power-on, warm-up, memory, internal processing, and so on, or operating with backscattering communication.

An A-IoT device can be an IoT device that satisfies one or more of the following (or variations thereof):
powered by energy harvesting, being either battery-less or with limited energy storage capability (e.g., using a capacitor) and the energy is provided through the harvesting of radio waves (including RF waveforms), light (including solar light or indoor light), motion, pressure, heat, or any other power source that could be seen suitable;
with low complexity, small size and lower capabilities and lower power consumption than previously defined 3GPP IoT devices (e.g., NB-IoT/enhanced machine type communication (eMTC) devices);
maintenance free and can have long life span (e.g., more than 10 years).

An A-IoT may directly communicate with a base station/gNB (e.g., the BS 102) (e.g., operating as a reader), or may indirectly communicate with a BS/gNB through an intermediate/assisting node, such as a handheld device/UE (for example, a “reader” UE that scans the A-IoT devices), a relay, integrated access and backhaul (IAB) node, a repeater for example a network-controlled repeater (NCR), and so on. The communication can be mono-static wherein the transmitter node to the A-IoT device is same as the receiving node from the A-IoT device, or can be bi-static (or multi-static) wherein the transmitter nodes to the A-IoT device can be different from the receiving nodes from the A-IoT device.

In various embodiments, the A-IoT device operates with energy storage and power management capability. These devices are characterized by ultra-low power consumption, and they employ energy harvesting mechanisms such as solar, RF energy and kinetic energy and thus don't require battery replacement or swapping frequently. In various embodiments, an A-IoT device operates with energy harvesting (EH) or with limited (or no) energy storage/battery capability (such as a capacitor), such as an energy storage unit for amplification of receptions at the UE (e.g., the UE 116) or transmission by the UE, or for other UE operations, such as power-on, warm-up, memory, internal processing, and so on, or operating with backscattering communication.

In various embodiments, the A-IoT device operates with RF envelope detection for receiving amplitude shift keying (ASK), e.g., OOK, modulated signal. RF envelope detection is a key function that enables the Ambient IoT devices to filter and analyze RF signals. This technique is applied in the reception of modulated RF signals with a view of acquiring information from the signals and hence enable communication between devices with efficiency and with minimum power consumption. RF envelope detection is one of the most important techniques that are used in many of the low power consumption wireless communication protocols that are employed in Ambient IoT systems.

In various embodiments, the A-IoT device may operate with impedance matching. Impedance matching may be utilized in passive Ambient IoT devices backscattering externally provisioned carrier wave (CW) signal.

The disclosure relates to defining functionalities and procedures for A-IoT device operations to exchange messages between a device and a reader. DL and UL are also referred to as reader-to-device (R2D) and device-to-reader (D2R), respectively, and vice versa.

FIG. 5 illustrates an example of a transmitter structure 500 using OFDM according to embodiments of the present disclosure. For example, transmitter structure 500 using OFDM can be implemented in gNB 102 of FIG. 1. This example is for illustration only and other embodiments can be used without departing from the scope of the present disclosure.

Information bits, such as DCI bits or data bits 510, are encoded by encoder 520, rate matched to assigned time/frequency resources by rate matcher 530, and modulated by modulator 540. Subsequently, modulated encoded symbols and demodulation reference signal (DM-RS) or channel state information reference signal (CSI-RS) 550 are mapped to REs 560, an inverse fast Fourier transform (IFFT) is performed by filter 570. A BW selector unit 565, a filter 580, a radio frequency (RF) amplifier 590, and transmitted signal 595 are also included.

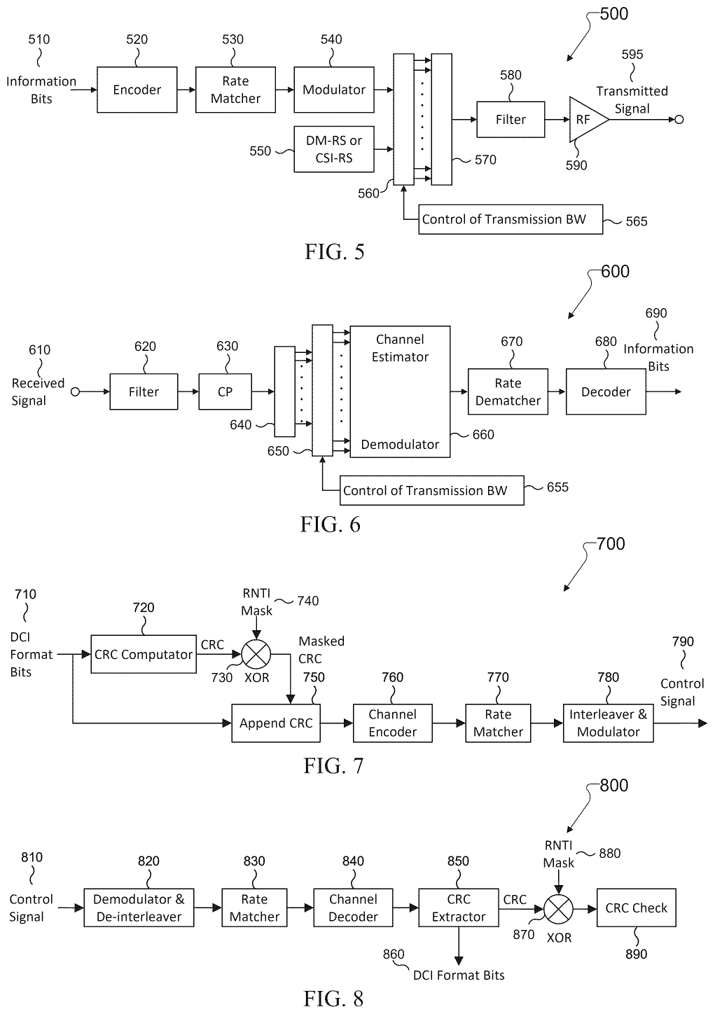

FIG. 6 illustrates an example of a receiver structure 600 using OFDM according to embodiments of the present disclosure. For example, receiver structure 600 using OFDM can be implemented by any of the UEs 111-116 of FIG. 1. This example is for illustration only and other embodiments can be used without departing from the scope of the present disclosure.

A received signal 610 is filtered by filter 620, a CP removal unit removes a CP 630, a filter 640 applies a fast Fourier transform (FFT), RE de-mapping unit 650 de-maps REs selected by BW selector unit 655, received symbols are demodulated by a channel estimator and a demodulator unit 660, a rate de-matcher 670 restores a rate matching, and a decoder 680 decodes the resulting bits to provide information bits 690.

With reference to FIG. 5, an example transmitter structure using OFDM according to this disclosure is shown.

With reference to FIG. 6, an example receiver structure using OFDM according to this disclosure is shown.

FIG. 7 illustrates an example encoding structure 700 for a downlink control information (DCI) format according to embodiments of the present disclosure. For example, encoding structure 700 can be implemented in gNB 102 of FIG. 1. This example is for illustration only and other embodiments can be used without departing from the scope of the present disclosure.

A gNB separately encodes and transmits each DCI format in a respective physical downlink control channel (PDCCH). When applicable, a radio network temporary identifier (RNTI) for a UE (e.g., the UE 116) that a DCI format is intended for masks a cyclic redundancy check (CRC) of the DCI format codeword in order to enable the UE to identify the DCI format. For example, the CRC can include 24 bits and the RNTI can include 16 bits or 24 bits. The CRC of (non-coded) DCI format bits 710 is determined using a CRC computation unit 720, and the CRC is masked using an exclusive OR (XOR) operation unit 730 between CRC bits and RNTI bits 740. The XOR operation is defined as XOR (0,0)=0, XOR (0,1)=1, XOR (1,0)=1, XOR (1,1)=0. The masked CRC bits are appended to DCI format information bits using a CRC append unit 750. An encoder 760 performs channel coding, such as polar coding, followed by rate matching to allocated resources by rate matcher 770. Interleaving and modulation units 780 apply interleaving and modulation, such as QPSK, and the output control signal 790 is transmitted.

FIG. 8 illustrates an example decoding structure 800 for a DCI format according to embodiments of the present disclosure. For example, decoding structure 800 for a DCI format can be implemented by any of the UEs 111-116 of FIG. 1. This example is for illustration only and other embodiments can be used without departing from the scope of the present disclosure.

A received control signal 810 is demodulated and de-interleaved by a demodulator and a de-interleaver 820. A rate matching applied at a gNB transmitter is restored by rate matcher 830, and resulting bits are decoded by decoder 840. After decoding, a CRC extractor 850 extracts CRC bits and provides DCI format information bits 860. The DCI format information bits are de-masked 870 by an XOR operation with a RNTI 880 (when applicable) and a CRC check is performed by unit 890. When the CRC check succeeds (check-sum is zero), the DCI format information bits are regarded to be valid. When the CRC check does not succeed, the DCI format information bits are regarded to be invalid.

With reference to FIG. 7, an example encoding process for a DCI format according to this disclosure is shown.

With reference to FIG. 8, an example decoding process for a DCI format for use with a UE according to this disclosure is shown.

It is envisaged that the number of connected devices will reach˜500 billion by 2030, which is about ˜59 times larger than the expected world population (˜8.5 billion) by that time. Mobile devices will take various form-factors, such as augmented reality (AR) glasses, virtual reality (VR) headsets, hologram devices, while a large portion of the devices will be Internet-of-Things (IoT) devices for improving productivity efficiency and increasing comforts of life. As the number of IoT devices grows exponentially, those IoT devices will become dominant in the next generation wireless communication systems such as fifth generation (5G) advanced, sixth generation (6G) systems, and so on.

With the explosive number of IoT devices, it may be challenging to power the IoT devices by battery that needs to be replaced or recharged manually, which leads to high maintenance cost. The automation and digitalization of various industries demand new IoT technologies of supporting batteryless devices with no energy storage capability or devices with energy storage that does not need to be replaced or recharged manually. Such types of devices are collectively termed as ambient IoT (A-IoT) in this disclosure, which is powered by various renewable energy sources such as radio waves, light, motion, or heat, etc. Use cases of A-IoT devices include asset inventory/tracking and remote environmental monitoring. The following list provides example use cases of A-IoT devices:
Indoor inventory
   Automated warehousing
   Medical instruments inventory management and positioning
   Non-Public Network for logistics
   Automobile manufacturing
   Airport terminal/shipping port
   Smart laundry
   Automated supply chain distribution
   Fresh food supply chain
   End-to-end logistics
   Flower auction
   Electronic shelf label
Indoor sensor
   Smart homes
   Base station machine room environmental supervision
   Smart laundry
   Smart agriculture
   Smart pig farm
   Cow stable
Indoor positioning
   Finding Remote Lost Item
   Location service
   Ranging in a home
   Personal belongings finding
   Positioning in shopping center
   Museum Guide
Indoor command
   Online modification of medical instruments status
   Device activation and deactivation
   Elderly Health Care
   Device Permanent Deactivation
   Electronic shelf label
Outdoor inventory
   Medical instruments inventory management and positioning
   Non-public network for logistics
   Airport terminal/shipping port
   Automated supply chain distribution
Outdoor sensor
   Smart grids
   Forest Fire Monitoring
   Dairy farming
   Smart manhole cover safety monitoring
   Smart bridge health monitoring
Outdoor positioning
   Finding remote lost item
   Location service
   Personal belongings finding
Outdoor command
   Online modification of medical instruments status
   Device activation and deactivation
   Elderly Health Care
   Controller in smart agriculture

Taking into account the limited size and low complexity required by practical applications of A-IoT devices, the output power of energy harvesting from ambient power sources is typically from 1 μW to a few hundreds of μW, which is orders of magnitude lower than normal user equipment (UE) having peak power consumption higher than 10 mW. This requires a new wireless access technology for A-IoT devices, which cannot be fulfilled by existing cellular systems including low-power IoT technologies such as NB-IoT and eMTC.

In the following, an italicized name for a parameter implies that the parameter is provided by higher layers.

DL (e.g., physical reader to device (R2D) channel (PRDCH)) transmissions or UL (e.g., PDRCH) transmissions can be based on an OFDM waveform including a variant using DFT precoding that is known as DFT-spread-OFDM that is typically applicable to UL transmissions.

In the following, subframe (SF) refers to a transmission time unit for the LTE RAT and slot refers to a transmission time unit for an NR RAT. For example, the slot duration can be a sub-multiple of the SF duration. NR can use a different DL or UL slot structure than an LTE SF structure. Differences can include a structure for transmitting physical downlink control channels (PDCCHs), locations and structure of demodulation reference signals (DM-RS), transmission duration, and so on. Further, eNB refers to a base station serving UEs operating with LTE RAT and gNB refers to a base station serving UEs operating with NR RAT. Exemplary embodiments provide a same numerology, that includes a sub-carrier spacing (SCS) configuration and a cyclic prefix (CP) length for an OFDM symbol, for transmission with LTE RAT and with NR RAT. In such case, OFDM symbols for the LTE RAT as same as for the NR RAT, a subframe is same as a slot and, for brevity, the term slot is subsequently used in the remaining of the disclosure.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}. 15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in v17.6.0 of [REF 1] and v17.6.0 of [REF 3].

DCI can serve several purposes. A DCI format includes a number of fields, or information elements (IEs), and is typically used for scheduling a PDSCH (DL DCI format) or a PUSCH (UL DCI format) transmission. A DCI format includes cyclic redundancy check (CRC) bits in order for a UE (e.g., the UE 116) to confirm a correct detection. A DCI format type is identified by a radio network temporary identifier (RNTI) that scrambles the CRC bits. For a DCI format scheduling a physical downlink shared channel (PDSCH) or a PUSCH for a single UE with RRC connection to a gNB (e.g., the BS 102), the RNTI is a cell RNTI (C-RNTI) or another RNTI type such as a modulation and coding scheme-cell RNTI (MCS-C-RNTI). For a DCI format scheduling a PDSCH conveying system information (SI) to a group of UEs, the RNTI is a system information RNTI (SI-RNTI). For a DCI format scheduling a PDSCH providing a response to a random access (RA) from a group of UEs, the RNTI is a random access (RA-RNTI). For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a paging RNTI (P-RNTI). For a DCI format providing transmission power control (TPC) commands to a group of UEs, the RNTI is a transmit power control radio network temporary identifier (TPC-RNTI), and so on. Each RNTI type is configured to a UE through higher layer signaling. A UE typically decodes at multiple candidate locations for PDCCH receptions as determined by an associated search space set.

For each DL bandwidth part (BWP) indicated to a UE in a serving cell, the UE can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can expect use of a same DM-RS precoder, a number of consecutive symbols for the CORESET, a set of resource blocks (RBs) for the CORESET, control channel element to resource element group (CCE-to-REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates

$${M}_{s}^{( L )}$$

per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in v17.6.0 of [REF2] or for DCI formats associated with scheduling broadcast/multicast PDSCH receptions, and for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number

$${n}_{s , f}^{μ}$$

in a frame with number n_{f} if

$$( {n}_{f} \cdot {N}_{slot}^{frame , μ} + {n}_{s , f}^{μ} - {o}_{s} ) mod {k}_{s} = 0.$$

The UE monitors PDCCH candidates for search space set s for Tₛ consecutive slots, starting from slot

$${n}_{s , f}^{μ} ,$$

and does not monitor PDCCH candidates for search space set s for the next kₛ-Tₛ consecutive slots. The UE determines CCEs for monitoring PDCCH according to a search space set based on a search space equation as described in [REF3].

A UE expects to monitor PDCCH candidates for up to 4 sizes of DCI formats that include up to 3 sizes of DCI formats with CRC scrambled by C-RNTI per serving cell. The UE counts a number of sizes for DCI formats per serving/scheduled cell based on a number of PDCCH candidates in respective search space sets for the corresponding active DL BWP. In the following, for brevity, that constraint for the number of DCI format sizes will be referred to as DCI size limit. When the DCI size limit would be exceeded for a UE based on a configuration of DCI formats that the UE monitors PDCCH, the UE aligns the size of some DCI formats, as described in v17.6.0 of [REF2], so that the DCI size limit would not be exceeded.

For each scheduled cell, the UE is not required to monitor on the active DL BWP with SCS configuration u of the scheduling cell more than

$$min ( {M}_{PDCCH}^{max , slot , μ} , {M}_{PDCCH}^{total , slot , μ} )$$

PDCCH candidates or more than

$$min ( {C}_{PDCCH}^{max , slot , μ} , {C}_{PDCCH}^{total , slot , μ} )$$

non-overlapped CCEs per slot, wherein

$${M}_{PDCCH}^{max , slot , μ} and {C}_{PDCCH}^{max , slot , μ}$$

are respectively a maximum number of PDCCH candidates and non-overlapping CCEs for a scheduled cell and

$${M}_{PDCCH}^{total , slot , μ} and {C}_{PDCCH}^{total , slot , μ}$$

are respectively a total number of PDCCH candidates and non-overlapping CCEs for a scheduling cell, as described in [REF3].

A UE does not expect to be configured CSS sets, other than CSS sets for multicast PDSCH scheduling, that result to corresponding total, or per scheduled cell, numbers of monitored PDCCH candidates and non-overlapped CCEs per slot on the primary cell that exceed the corresponding maximum numbers per slot. For USS sets or for CSS sets associated with multicast PDSCH scheduling, when a number of PDCCH candidates or non-overlapping CCEs in a slot would exceed the limits/maximum per slot for scheduling on the primary cell mentioned herein, the UE selects the USS sets or the CSS sets to monitor corresponding PDCCH in an ascending order of a corresponding search space set index until and an index of a search space set for which PDCCH monitoring would result to exceeding the maximum number of PDCCH candidates or non-overlapping CCEs per slot for scheduling on the PCell as described in [REF3].

For same cell scheduling or for cross-carrier scheduling where a scheduling cell and scheduled cells have DL BWPs with same SCS configuration μ, a UE does not expect a number of PDCCH candidates, and a number of corresponding non-overlapped CCEs per slot on a secondary cell to be larger than the corresponding numbers that the UE is capable of monitoring on the secondary cell per slot. For cross-carrier scheduling, the number of PDCCH candidates for monitoring and the number of non-overlapped CCEs per slot are separately counted for each scheduled cell.

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in v17.6.0 of [REF3] and [REF4].

MIMO technologies have a key role in boosting system throughput both in NR and LTE and such a role will continue and further expand in the future generations of wireless technologies. For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

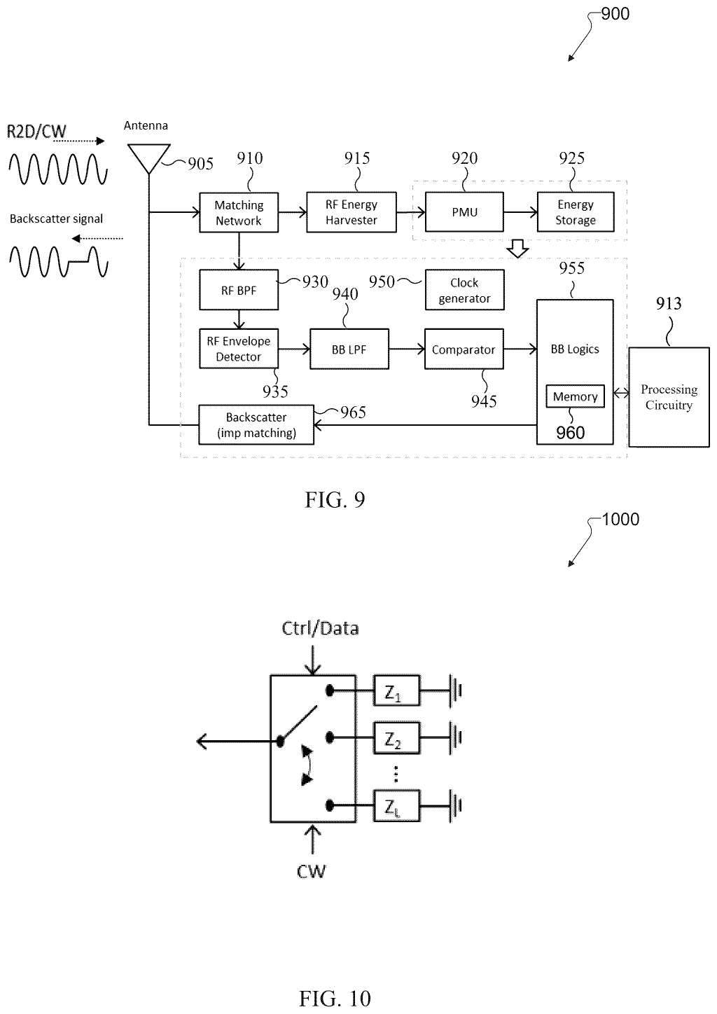

FIG. 9 illustrates a diagram of an example type-1 backscatter structure 900 for IoT devices according to embodiments of the present disclosure. For example, type-1 backscatter structure 900 can be implemented by any of the UEs 111-116 of FIG. 1, or may be devices with fewer components and functionality than a UE. This example is for illustration only and other embodiments can be used without departing from the scope of the present disclosure.

As shown in FIG. 9, the type-1 backscatter structure 900 for IoT devices includes an antenna 905, a matching network 910, a RF energy harvester 915, a power measurement unit (PMU) 920, an energy storage 925, a RF bandpass filter (BPF) 930, a RF envelope detector 935, a baseband (BB) lowpass filter (LPF) 940, a comparator 945, a clock generator 950, a BB logistics 955, a memory 960, backscatter (imp matching) 965, and processing circuitry 913.

In various embodiments, the processing circuitry 913, which may be a full-powered processor, such as included in UE 116, a lower-power microprocessor or microcontroller, an application specific integrated circuit (ASIC), or logic circuitry. The processing circuitry 913 can control the overall operation of the IoT device including determination of reception and/or transmission timing. The processing circuitry 913 may be powered via energy storage 925. The signal receiving and transmitting processing circuitry included in the IoT devices, such as RF BPF 930, a RF envelope detector 935, a BB LPF 940, a comparator 945, a clock generator 950, a BB logistics 955, a memory 960, and a backscatter (impedance matching) 965, may be referred to as a transceiver, which may use separate antennas for reception and transmission, respectively, or may use a common antenna, such as antenna 905 for transmission and reception. One or more implementations described herein further include other implementation variations such as separate Tx-Rx antennas vs common Tx-Rx antenna, use of a sensor, etc. The implementations should be understood as an example and not as a restriction.

FIG. 10 illustrates a diagram of an example impedance matching circuit according to embodiments of the present disclosure. For example, impedance matching circuit 1000 can be implemented in any of the IoT device described herein. This example is for illustration only and other embodiments can be used without departing from the scope of the present disclosure.

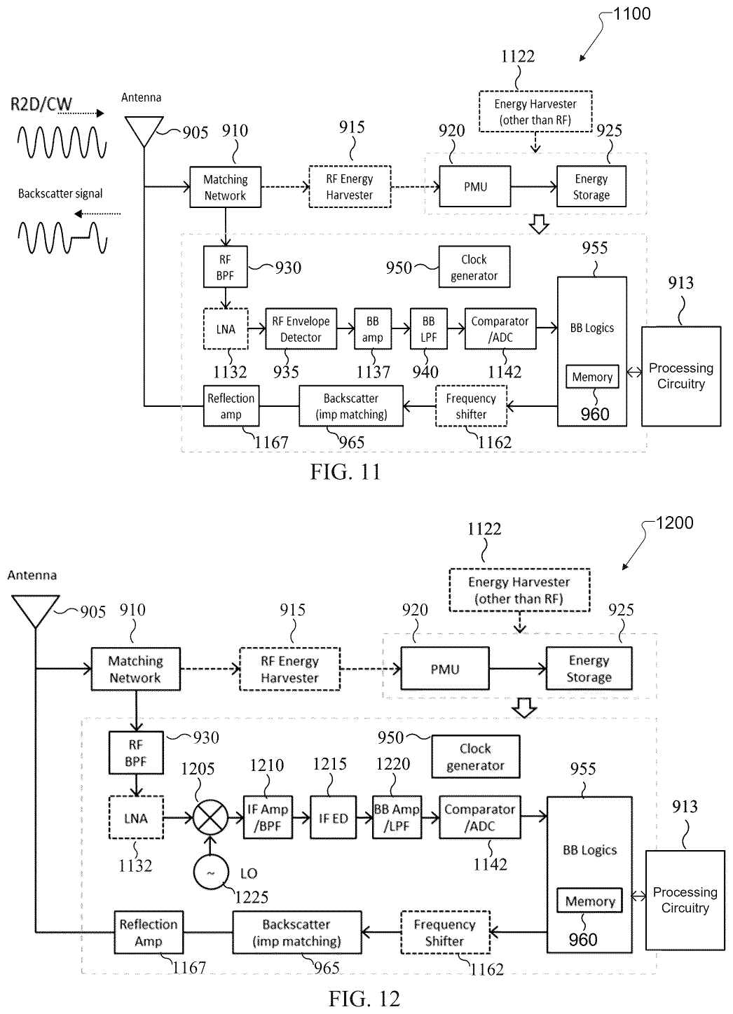

FIG. 11 illustrates a diagram of an example type-2a backscatter structure 1100 for IoT devices according to embodiments of the present disclosure. For example, backscatter structure 1100 can be implemented by any of the UEs 111-116 of FIG. 1, such as the UE 111, or may be devices with fewer components and functionality than a UE. This example is for illustration only and other embodiments can be used without departing from the scope of the present disclosure.

As shown in FIG. 11, the type-2a backscatter structure 1100 includes an antenna 905, a matching network 910, a RF energy harvester 915, a PMU 920, an energy storage 925, an energy harvester (other than RF) 1122, a RF BPF 930, a low noise amplifier (LNA) 1132, a RF envelope detector 935, a BB amp 1137, a BB LPF 940, a comparator/ADC 1142, a clock generator 950, a BB logistics 955, a memory 960, a frequency shifter 1162, backscatter (imp matching) 965, a reflection amp 1167, and processing circuitry 913.

FIG. 12 illustrates a diagram of an example type-2a backscatter structure 1200 for IoT devices according to embodiments of the present disclosure. For example, backscatter structure 1200 can be implemented by any of the UEs 111-116 of FIG. 1, such as the UE 112, or may be devices with fewer components and functionality than a UE. This example is for illustration only and other embodiments can be used without departing from the scope of the present disclosure.

As shown in FIG. 12, the type-2a backscatter structure 1200 includes an antenna 905, a matching network 910, a RF energy harvester 915, a PMU 920, an energy storage 925, an energy harvester (other than RF) 1122, a RF BPF 930, a LNA 1132, a mixer 1205, a LO 1225, an IF amp/BPF 1210, an IF ED 1215, a BB Amp/LPF 1220, a comparator/ADC 1142, a clock generator 950, a BB logistics 955, a memory 960, a frequency shifter 1162, a backscatter (impedance Matching) 965, reflection amp 1167, and processing circuitry 913.

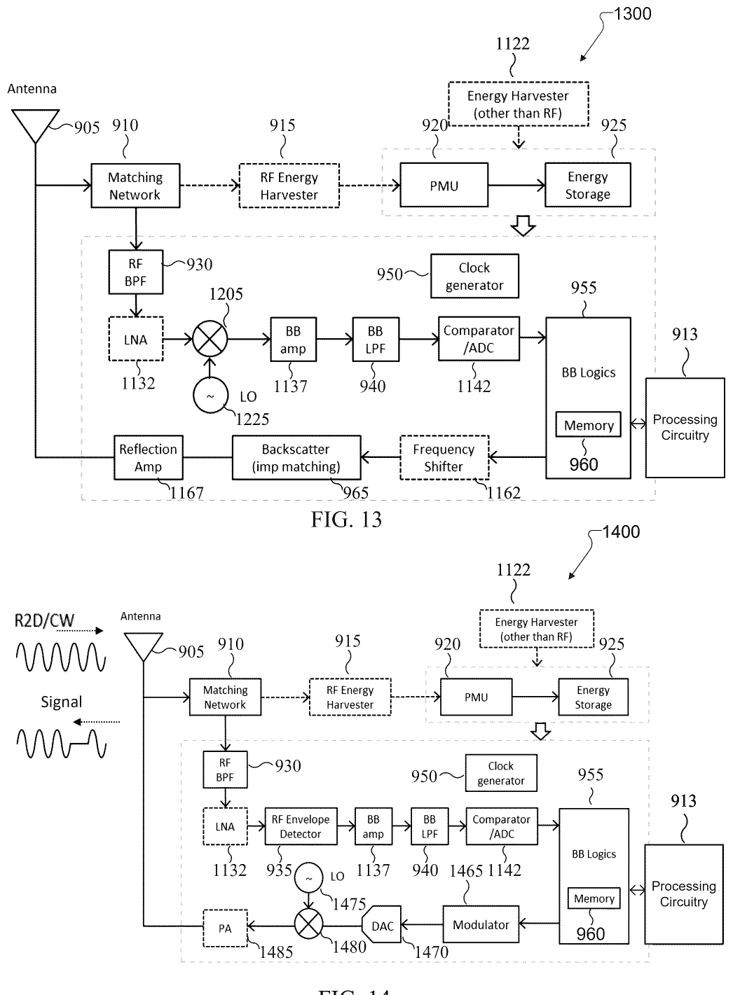

FIG. 13 illustrates a diagram of an example type-2b active structure 1300 for IoT devices according to embodiments of the present disclosure. For example, structure 1300 can be implemented by any of the UEs 111-116 of FIG. 1, such as the UE 113, or may be devices with fewer components and functionality than a UE. This example is for illustration only and other embodiments can be used without departing from the scope of the present disclosure.

As shown in FIG. 13, the type-2b active structure 1300 includes an antenna 905, a matching network 910, a RF energy harvester 915, a PMU 920, an energy storage 925, an energy harvester (other than RF) 1122, a RF BPF 930, a LNA 1132, a mixer 1205, an LO 1225, a BB amplifier 1137, a BB LPF 940, a comparator/ADC 1142, a clock generator 950, a BB logistics 955, a memory 960, a frequency shifter 1162, a backscatter (impedance matching) 965, a reflection amp 1167, and processing circuitry 913.

FIG. 14 illustrates a diagram of an example type-2b active structure 1400 for IoT devices according to embodiments of the present disclosure. For example, backscatter structure 1400 can be implemented by any of the UEs 111-116 of FIG. 1, such as the UE 114, or may be devices with fewer components and functionality than a UE. This example is for illustration only and other embodiments can be used without departing from the scope of the present disclosure.

As shown in FIG. 14, the type-2b active structure 1400 includes an antenna 905, a matching network 910, a RF energy harvester 915, a PMU 920, an energy storage 925, an energy harvester (other than RF) 1122, a RF BPF 930, a LNA 1132, a RF envelope detector 935, a BB amp 1137, a BB LPF 940, a comparator/ADC 1142, a clock generator 950, a BB logistics 955, a memory 960, a modulator 1465, a digital to analog converter (DAC) 1470, a LO 1475, a mixer 1480, a PA 1485, and processing circuitry 913.

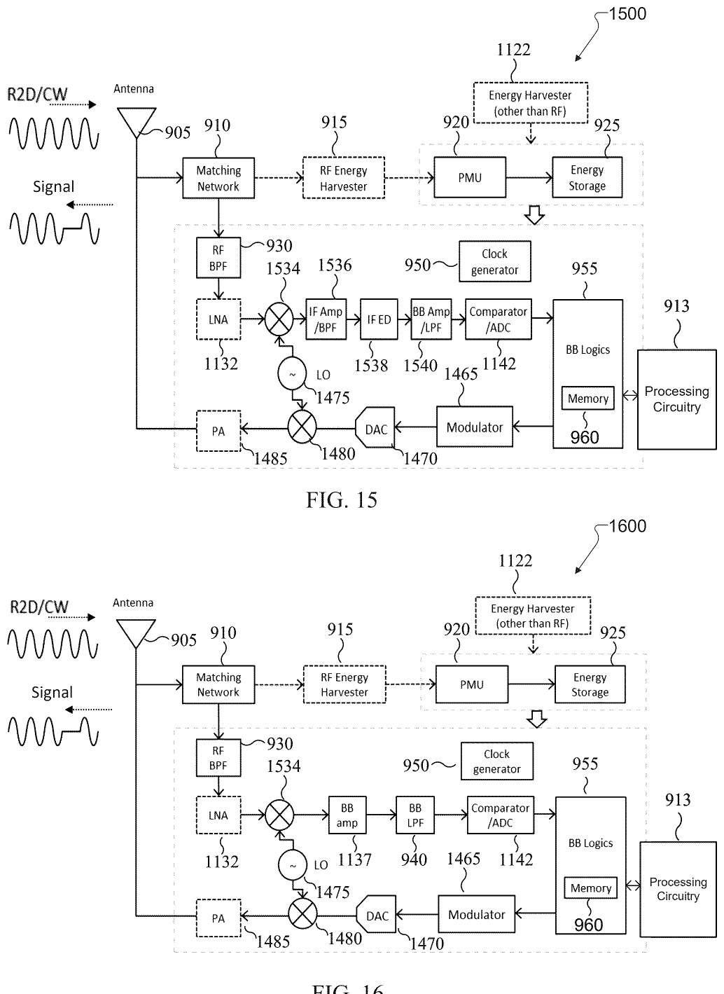

FIG. 15 illustrates a diagram of an example type-2b active structure 1500 for IoT devices according to embodiments of the present disclosure. For example, backscatter structure 1500 can be implemented by any of the UEs 111-116 of FIG. 1, such as the UE 115, or may be devices with fewer components and functionality than a UE. This example is for illustration only and other embodiments can be used without departing from the scope of the present disclosure.

As shown in FIG. 15, the structure 1500 includes an antenna 905, a matching network 910, a RF energy harvester 915, a PMU 920, an energy storage 925, an energy harvester (other than RF) 1122, a RF BPF 930, a LNA 1132, a mixer 1534, an IF amp/BPF 1536, an IF ED 1538, a BB amp/LPF 1540, a comparator/ADC 1142, a clock generator 950, a BB logistics 955, a memory 960, a modulator 1465, a DAC 1470, a LO 1475, a mixer 1480, a PA 1485, and processing circuitry 913.

FIG. 16 illustrates a diagram of an example type-2b active structure 1600 for IoT devices according to embodiments of the present disclosure. For example, backscatter structure 1600 can be implemented by any of the UEs 111-116 of FIG. 1, such as the UE 116, or may be devices with fewer components and functionality than a UE. This example is for illustration only and other embodiments can be used without departing from the scope of the present disclosure.

As shown in FIG. 16, the structure 1600 includes an antenna 905, a matching network 910, a RF energy harvester 915, a PMU 920, an energy storage 925, an energy harvester (other than RF) 1122, a RF BPF 930, a LNA 1132, a mixer 1534, a BB amp 1137, a BB LPF 940, a comparator/ADC 1142, a clock generator 950, a BB logistics 955, a memory 960, a modulator 1465, a DAC 1470, a LO 1475, a mixer 1480, a PA 1285, and processing circuitry 913.

Several different types of A-IoT devices can be regarded as following.
Device 1: ˜1 μW peak power consumption, has energy storage, initial sampling frequency offset (SFO) up to 10× ppm, neither R2D nor D2R amplification in the device. The device's D2R transmission is backscattered on a carrier wave provided externally.
Device 2a: ≤a few hundred μW peak power consumption, has energy storage, initial sampling frequency offset (SFO) up to 10× ppm, both R2D and/or D2R amplification in the device. The device's D2R transmission is backscattered on a carrier wave provided externally.
Device 2b: ≤a few hundred μW peak power consumption, has energy storage, initial sampling frequency offset (SFO) up to 10× ppm, both R2D and/or D2R amplification in the device. The device's D2R transmission is generated internally by the device.

The devices may operate in frequency division duplexing (FDD) spectrum or time division duplexing (TDD) spectrum, which may be licensed or unlicensed.

In the following, reference architectures for the device types herein are provided, which should be understood as an example and not as a restriction.

With reference to FIG. 9, an example Type-1 backscatter device structure according to the disclosure is shown.

The RF energy harvester 915 converts RF signal to DC power and supplies the device. Either a R2D signal or an externally provisioned CW signal for backscattering can be utilized for RF energy harvesting. The CW is externally provided from a gNB or a dedicated source. The source of CW signal, e.g., either a gNB or a dedicated node, may or may not be agnostic to A-IoT devices. The harvested energy, e.g., using a rectifier, can be stored using a capacitor, super-capacitor, or, generally speaking, an energy storage. Antenna could be either shared or separate for RF energy harvester and receiver/transmitter. Matching network 910 is to match impedance between antenna and other components. Clock generator 950 provides required clock signal(s).

The PMU 920 manages storing energy to energy storage from energy harvester and supplying power to active component blocks which needs power supply. The PMU 920 can also transition the device operation state between at least ON state, the OFF state, and the power saving (PS) state. The PMU 920 includes or is implemented by power management circuitry. In some embodiments, the PMU 920 may be implemented by program code (e.g., software or firmware) executed by one or more processors such as the processing circuitry 913, such that, in some embodiments, the power management circuitry of the PMU 920 is the same as or includes at least some of the processing circuitry 913. In other embodiments, the power management circuitry of the PMU 920 may be a separate processor, controller, or circuit, such as a lower-power microprocessor or microcontroller, an ASIC, or logic circuitry that is programmed to implement the functions of the PMU 920 or configured to implement the functions of the PMU 920 in logic.

The R2D signal is demodulated using a low complexity envelope detector and comparator, whose output is provided as an input to the baseband circuit. Given the low-power and low-complexity requirements of the Type-1 backscatter device, an RF envelope detection can be a viable solution for a receiver architecture, compared to a heterodyne architecture with IF envelope detection or a homodyne architecture with baseband envelope detection, which require LO and frequency mixer for frequency down-conversion. The input RF signal passes through an RF band-pass filter (BPF) 930 for an adjacent channel interference suppression, and then the filtered RF signal is directly converted into a baseband using an RF envelope detector 935, followed by a baseband low-pass filter (LPF) 940 for filtering out harmonics and high frequency components, and an n-bit comparator, where n can be 1, 2, 4, 8, . . . . The use of filters, e.g., BPF 930 only, LPF 940 only, or both, can be an implementation choice.

For the D2R backscatter transmission, any of the following can be used:
Case 1) CW is provisioned at DL spectrum and backscattered, i.e., CW @ DL spectrum, D2R backscattering @ DL spectrum.
Case 2) CW is provisioned at UL spectrum and backscattered, i.e., CW @ UL spectrum, D2R backscattering @ UL spectrum.
Case 3) CW is provisioned at DL spectrum, frequency shifted to UL spectrum, and then backscattered, i.e., CW @ DL spectrum, D2R backscattering @ UL spectrum.

In one example, Case 1) or Case 2) is evaluated for device 1, i.e., CW and D2R backscattering on the same frequency and, therefore, a frequency shifter (FS) is not required.

With reference to FIG. 10, an example impedance matching circuit for backscatter device D2R modulation according to the disclosure is shown.

The following are simple examples of impedance matching operations:
Open circuit: Full reflection of the received CW signal in the same phase. This can be used for OOK modulation with matching circuit.
Short circuit: Full reflection of the received CW signal in the reversed phase. This can be used for phase-shift keying (PSK) modulation.
Matching circuit: No reflection as the impedance is matched to a load, i.e., absorption. This can be utilized for energy harvesting, Rx mode, or modulation with other matching states.
Multi-level matching circuit: As illustrated in FIG. 10. Multi-level impedance matching to Z₁, Z₂, . . . , Z_{L} for log₂ (L) bits per symbol ASK modulation.

Depending on the matched load impedance, the matching circuit can backscatter the incoming CW signal with different reflection coefficients in both amplitude and phase. In general, amplitude shift keying (ASK)/phase shift keying (PSK)/frequency shift keying (FSK) may be supported using an impedance matching circuit. As a simplest modulation scheme, OOK may be evaluated. The device may indicate its modulation capability or impedance matching capability to the network (e.g., the network 130), or certain requirement may be predefined in the specification of system operation.

With reference to FIG. 11, an example device 2a backscatter architecture based on RF envelope detection according to the disclosure is shown.

The device 2a may share similar structure at large with device 1 as the D2R transmission is still based on backscattering of an externally provided CW, while the device 2a may differ from device 1 from the following aspects.

The device 2a has ≤a few hundred μW peak power consumption and both R2D and/or D2R amplification in the device. In this case, alternative to the RF energy harvesting from a R2D signal or an externally provided CW signal, other renewable energy sources, e.g., solar, thermal, kinetic, etc., may be provided for energy harvesting. The presence of a certain energy harvesting capability from a certain renewable energy source may be expected for system design point of view. The use of energy harvesters, e.g., RF energy harvester 915 only, other energy harvester only, or both, can be an implementation choice.

The device 2a may be equipped with both R2D and/or D2R amplification in the device. Given the power consumption requirement, i.e., ≤a few hundred μW, the R2D/D2R amplification for device 2a may be based on an architecture that is different from the typical power amplifier (PA) and low noise amplifier (LNA). In some example low-power/complexity architectures for forward amplifier for reader-to-device (R2D) reception and reflection amplifier for device-to-reader (D2R) transmission, a single bipolar transistor terminated with microstrips may be used. The receiver amplification can be either RF amplification prior to the envelope detector, baseband amplification after the envelope detector, or both, which is an implementation choice. In one example, a reflection amplifier is used for both R2D reception and D2R transmission, and LNA may or may not exist. In another example, a reflection amplifier is used for D2R transmission only and LNA is used for R2D reception amplification.

In one example, a reflection amplifier can be used only for backscattering, i.e., one-way amplification. In another example, a reflection amplifier can be used for both backscattering and receiving, i.e., two-way amplification. For a reflection amplifier, it can be expected that 10˜25 dB gain is achievable, at a power consumption of a few tens to hundreds micro-Watts. It is noted that an exact power consumption value will be highly dependent on implementations. On the other hand, a stability of an amplifier is a function of an input impedance and operating frequency. Since A-IoT devices are expected to be deployed for a certain operating frequency and not expected to adapt to another frequency after deployment, the implementation can ensure a stable operation of the amplifier for the target frequency.

One additional difference of device 2a compared to device 1 may be a use of a FS. With a few hundred μW peak power consumption, some low-power LO architectures with a frequency mixer can be taken into account for Case 3). With FS, it can be expected that the CW is provided in a frequency different than the UL carrier frequency. Because the A-IoT devices are targeting for low complexity and low power consumption, the following options can be evaluated as an example method for frequency shift:
Ultra-low power local oscillator (LO), whose output frequency is multiplied in one or more stages using a frequency multiplier to obtain a desired amount of frequency shift.
Calibrated RC (resistor-capacitor) oscillator, which uses CW frequency as an input to the RC oscillator with phase locked loop (PLL) circuitry.
CW signal provided at the UL carrier frequency; In this case, no frequency shifter is needed.
Use of harmonic frequencies of CW signal or intermodulation frequencies of two-tone CW signals.

The device 2a receiver architecture may be based on RF envelope detector, intermediate frequency (IF) envelope detector (ED), i.e., heterodyne receiver, or homodyne receiver with zero IF, as exemplified for device 2b.

The device 2b shares similar structure at large with the device 2a other than the UL signal is internally generated using LO rather than backscattering the externally provided CW. The example architecture shown in FIGS. 12-14 is based on an active transmitter chain, wherein the UL data is modulated, converted to an analog signal using digital to analog converter (DAC) and, then up-converted to a UL carrier frequency using LO and frequency mixer, which is followed by an amplifier.

In FIG. 12, the DL receiver chain is still based on the RF envelope detector as in the previous architectures. In FIG. 13, the DL receiver chain is based on heterodyne receiver with IF envelope detector. In the heterodyne architecture, the RF signal is down converted into an intermediate frequency and then detected using an envelope detector. In FIG. 14, the DL receiver is based on homodyne receiver, i.e., zero-IF. In the homodyne/zero-IF architecture, the RF signal is directly down converted into baseband signal and then detected using a comparator/ADC.

FIGS. 9-14 should be understood for illustration purpose only. There can be other components not explicitly shown in the figure such as switch, duplexer, and filters, or some components may be replaced to different options. Also, the devices can operate both in TDD and FDD spectrum, either licensed or unlicensed, and, depending on the operating spectrum, the actual architectures can be different from the conceptual illustrations in the figures.

For R2D transmission at least OOK modulation is used. For D2R transmission, one or more of OOK, binary PSK, binary FSK can be used. The general principle for OOK signal generation based on CP-OFDM waveform includes encoding OOK chips generated by encoding schemes on top of CM-OFDM waveform. Such encoding schemes include Manchester encoding, PIE (Pulse-Interval Encoding), Miller encoding, FM0 encoding, any other types of line-coding schemes, or even no line-coding schemes such as based on square-wave modulation. The following OOK schemes based on CP-OFDM waveform can be taken into account.
OOK-1: Single-chip in 1 OFDM symbol. OOK=1 means N sub-carriers (SCs) are modulated. OOK=0 means SCs are zero power (from base-band point of view).
OOK-2: Parallel M-bit OOK in frequency domain. N SCs are further separated into M segments with guard-bands in-between and/or around. OOK=1 means SCs in segment are modulated. OOK=0 means SCs in segment are zero power (from base-band point of view).
OOK-3: Multi-tone single-bit OOK. N SCs are separated into L segments without guard-bands in-between segment, but around. OOK=1 means 1 sub-carrier (known by receiver) of each segment is modulated, rest of SC is zero power (from base-band point of view). OOK=0 means SCs in segments are zero power (from base-band point of view).
OOK-4: Transform M-bit OOK in time domain. N SCs of OOK-1 are generated by a transformation (DFT/Least square). N′ samples are generated from M-bits. Signal modification and/or truncation may or may not be used. The resulting samples, N, are mapped to N SCs.

The disclosure is applicable to any encoding schemes, any OOK modulation schemes with different M values if applicable, or any underlying waveforms such as CP-OFDM or its variants including DFT-s-OFDM, etc.

In deploying A-IoT devices, different topology options can be evaluated. The following provides examples of topology options:
Topology 1: BS↔A-IoT device.
   An A-IoT device directly and bidirectionally communicates with a basestation. The communication between the basestation and the A-IoT device includes A-IoT data and/or signalling. This topology includes the BS transmitting to the A-IoT device is different from the BS receiving from the A-IoT device.
Topology 2: BS↔intermediate node↔Ambient IoT device
   An A-IoT device communicates bidirectionally with an intermediate node between the device and basestation. In this topology, the intermediate node can be a relay, IAB node, UE, repeater, etc. which is capable of A-IoT. The intermediate node transfers A-IoT data and/or signalling between BS and the A-IoT device. The intermediate node is referred to as I-node in this disclosure.
Topology 3: BS↔assisting node↔Ambient IoT device↔BS.
   An A-IoT device transmits data/signalling to a basestation, and receives data/signalling from the assisting node; or the A-IoT device receives data/signalling from a basestation and transmits data/signalling to the assisting node. In this topology, the assisting node can be a relay, IAB, UE, repeater, etc. which is capable of A-IoT.
Topology 4: UE↔Ambient IoT device
   An A-IoT device communicates bidirectionally with a UE. The communication between UE and the A-IoT device includes A-IoT data and/or signalling.

This disclosure is applicable at least to the following deployment scenarios:
Scenario 1: Device indoors, BS indoors
Scenario 2: Device indoors, BS outdoors
Scenario 3: Device indoors, UE-based reader
Scenario 4: Device outdoors, BS outdoors
Scenario 5: Device outdoors, UE-based reader

The deployment of A-IoT can be on the same sites as an existing 3GPP deployment corresponding to the BS type, e.g., macro-cell, micro-cell, pic-cell, etc. In some embodiments, it may be expected that the deployment of A-IoT can be on new sites without an expectation of an existing 3GPP deployment. The deployment can be based on licensed or unlicensed TDD or FDD spectrum, which may be in-band to an existing deployment, in guard-band of an existing deployment, or in a standalone band. Different traffic types can be supported including device-terminated (DT) and device-originated (DO), wherein DO traffic can be further divided into DO autonomous (DO-A), and DO device-terminated triggered (DO-DTT) types.

A-IoT device is one type of a UE. Embodiments in this disclosure can be generally applicable to other types of UEs, e.g., smartphones, AR/VR devices, or any other types of IoT devices.

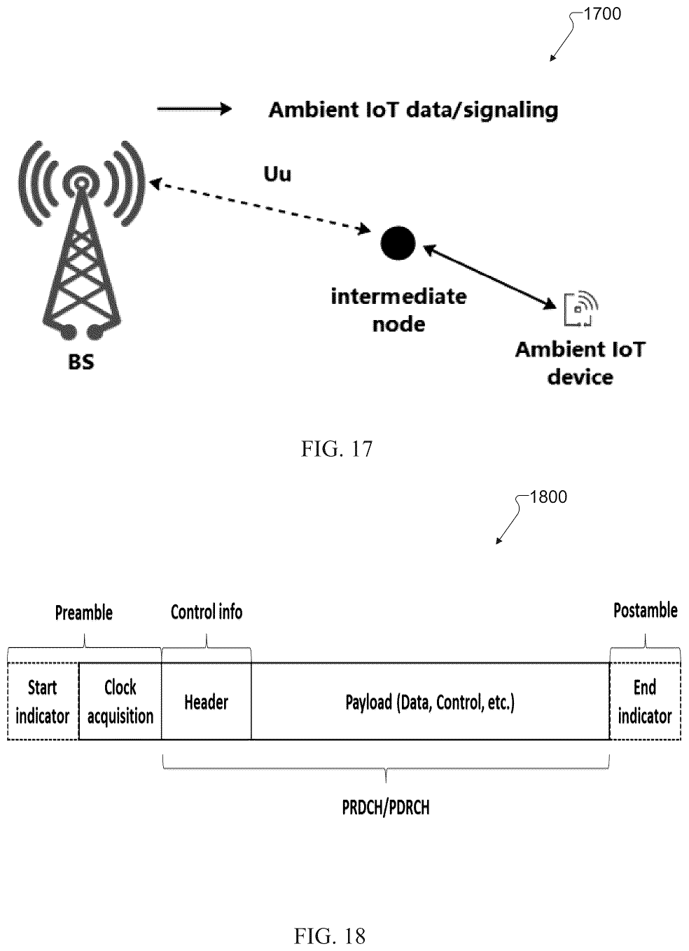

FIG. 17 illustrates an example system 1700 for D2R/R2D transmission including an intermediate UE according to embodiments of the present disclosure. For example, system 1700 can be implemented in the wireless network 100 of FIG. 1. This example is for illustration only and other embodiments can be used without departing from the scope of the present disclosure.

With reference to FIG. 17, a topology involving an intermediate node is shown, wherein the intermediate node (I-node) can be any of a UE, relay, repeater, a dedicated node, or a gNB (e.g., the BS 102). Any operations performed by a BS can be also performed by the I-node instead of the BS, and all or part of interfaces are transparent to the A-IoT devices.

An entity directly communicating with a device, or tag, is collectively termed as a reader, which can be an intermediate node as illustrated in FIG. 17, an assisting node, a UE, or a BS directly communicating with a device.

This disclosure is applicable to any of the following spectrum options, wherein a reader can be any of a BS, an intermediate node, an assisting node, or a UE in any of the topologies or scenarios disclosed herein:
CW is transmitted on DL spectrum and D2R is transmitted on the DL spectrum or shifted to UL spectrum.
CW is transmitted on UL spectrum and D2R is transmitted on the UL spectrum or shifted to DL spectrum.
R2D transmission by a reader is on DL spectrum or UL spectrum.
A node transmitting the CW can be a node inside the topology, e.g., a BS, an intermediate node, an assisting node, or a UE (e.g., the UE 116), or a node outside the topology, e.g., a dedicated CW source.
A reader receiving D2R transmission and a reader transmitting R2D may be the same or different.
As an example, CW is transmitted on DL spectrum and D2R transmission is shifted to UL spectrum, wherein the node transmitting the CW is a node inside topology or outside topology, and a reader transmitting R2D and a reader receiving D2R may be the same or different.
As another example, CW is transmitted on DL or UL spectrum and D2R transmission is on the same spectrum for which the CW is transmitted, wherein the node transmitting the CW is a node inside topology or outside topology, and a reader transmitting R2D and a reader receiving D2R may be the same or different.

A physical channel for reader to device transmission is referred to as a physical reader to device (R2D) channel (PRDCH), and a physical channel for device to reader transmission is referred to as a physical device to reader (D2R) channel (PDRCH) in this disclosure.

For PRDCH and PDRCH transmission, a timing acquisition signal, e.g., a preamble, is included at least for timing acquisition and for indicating the start of the transmission in time domain, respectively.

There may be a timing relationship between transmissions as herein:
T_{R2D_min}, T_{R2D_max}: Minimum/maximum time between a R2D transmission and the corresponding D2R transmission following it.
T_{D2R_min}, T_{D2R_max}: Minimum/maximum time between a D2R transmission and the corresponding R2D transmission following it.
T_{R2D_R2D_min}, T_{R2D_R2D_max}: Minimum/maximum time between two different consecutive R2D transmissions to the same A-IoT device.
T_{D2R_D2R_min}, T_{D2R_D2R_max}: Minimum/maximum time between two different consecutive D2R transmissions from the same A-IoT device.

FIG. 18 illustrates an example signal structure 1800 for A-IoT systems according to embodiments of the present disclosure. For example, signal structure 1800 can be received by any of the devices described herein. This example is for illustration only and other embodiments can be used without departing from the scope of the present disclosure.

With reference to FIG. 18, an example signal structure used for A-IoT system for R2D or D2R transmission according to the disclosure is shown. The dotted block indicates that it may or may not exist.

The first figure in FIG. 18 illustrates a general signal structure comprised of one or more of the following elements:
Start-indicator, i.e., delimiter: Start-of-signal indication. It may be a short duration of low voltage signal or an ON/OFF pattern, i.e., high/low voltage transmission. The start-indicate may present in the PRDCH, and it may not be present in the PDRCH.
Postamble, i.e., end-indicator: It may be a short duration of a low voltage signal or an ON/OFF pattern, i.e., high/low voltage transmission. The postamble may or may not be present depending on the system design. In one example, the presence of the postamble for PRDCH is indicated in the PRDCH control/header part. Similarly, in one example, the attachment of the postamble for PDRCH is indicated in the preceding PRDCH control/header part.
Clock acquisition: A sequence that provides OOK chip rate acquisition, which is used to detect OOK chips for the rest of the signal, and the chip synchronization. The clock acquisition part is a part of preamble.
Header: The header field carries necessary information for R2D or D2R signal reception, providing L1 or L2 control information
Payload: The field provides data including any of L1, L2, or higher layer control information, system information, etc.

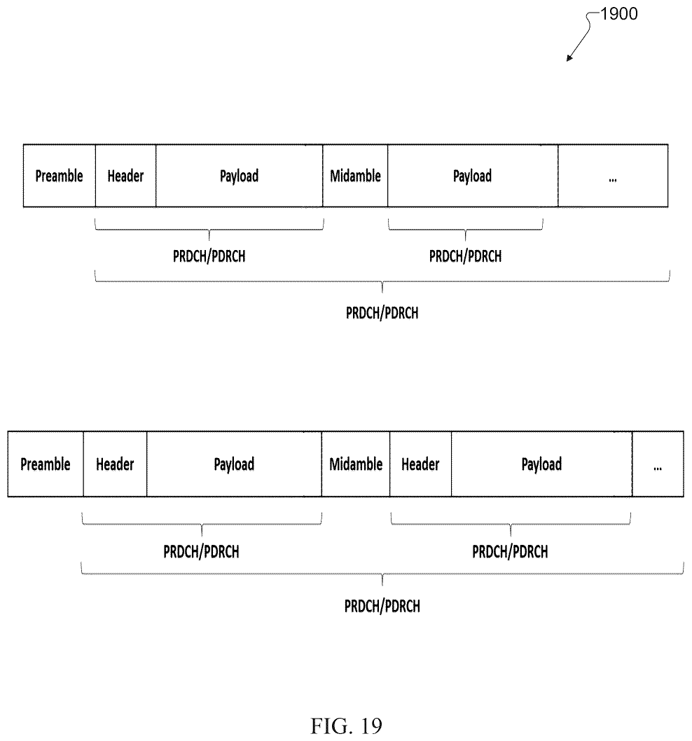

FIG. 19 illustrates example signal structures 1900 for A-IoT systems according to embodiments of the present disclosure. For example, signal structures 1900 can be received by any of the devices described herein. This example is for illustration only and other embodiments can be used without departing from the scope of the present disclosure.

With reference to FIG. 19, an example signal structure used for A-IoT system for R2D or D2R transmission with midamble according to the disclosure is shown. The dotted block indicates that it may or may not exist.

When a transmission is longer than a certain threshold, which may be predefined in a specification of system operations or indicated to the device for reception or transmission from the device, the payload may be divided into multiple segments with midamble. A single header for the entire payload, or one or more headers for each segments of the payload may be provided. A single CRC for the entire payload (either inclusive or non-inclusive of the header) or one or more CRCs for each segments of the payload may be provided.

In one example, the insertion of the midamble is only for PDRCH. In another example, the insertion of the midamble is both for PDRCH and PRDCH.

In one example, as illustrated in the upper figure, the payloads segmented by the midambles are not attached with a separate control/header field. In another example, as illustrated in the lower figure, the payloads segmented by the midambles are attached with separate control/header field. In one example, the entire transmission is regarded as one PRDCH or PDRCH. In another example, the midamble is not regarded as a part of PRDCH or PDRCH and the transmissions separated by the midamble are regarded as a separate PRDCH to your PDRCH.

One main use case of A-IoT is inventory, e.g., asset identification and tracking, while the reader may not have a prior knowledge of devices in its proximity. Therefore, embodiments of the present disclosure recognize that there is a need to define procedures and methods for device identification via random access.

A device may be unavailable or time to time for a certain time duration due to the lack of energy and for charging by harvesting energy. This may impact the inventory process, if a device's remaining energy level cannot sustain the current inventory process. This may also impact a transmission or a reception if a device's remaining energy level cannot sustain the current transmission or reception duration.

The disclosure relates to a communication system. The disclosure relates to defining functionalities and procedures for communication with A-IoT devices which may be lacking a precise timing capability and have a limited operation time due to energy harvesting.

The disclosure also relates to defining functionalities and procedures for a device to perform random access for inventory and defining timing parameters for exchanging messages during random access.

The disclosure also relates to defining functionalities and procedures for a device to receive a PRDCH providing group-ACK message 2 in response to a PDRCH transmission providing message 1 during random access.

The disclosure also relates to defining functionalities and procedures for a device to receive a PRDCH providing message 2 from a burst of PRDCH transmissions providing message 2 in response to a PDRCH transmission providing message 1 during random access.

The disclosure also relates to defining functionalities and procedures for a device to receive a PRDCH providing message 2, indicating a request for certain data or a command, and transmit PDRCH providing message 3 during random access.

The disclosure also relates to defining functionalities and procedures for defining a time unit for timing indication and a device to determine a PDRCH transmission timing.

The disclosure also relates to defining functionalities and procedures for a device to determine a PRDCH chip length.

The disclosure also relates to defining functionalities and procedures for a device to determine a PDRCH chip length.

Embodiments of the disclosure for communication with A-IoT devices, which may be lacking a precise timing capability and have a limited operation time due to energy harvesting, are summarized in the following and are fully elaborated further herein.
Method and apparatus for a device to perform random access for inventory and defining timing parameters for exchanging messages during random access.
Method and apparatus for a device to receive a PRDCH providing group-ACK message 2 in response to a PDRCH transmission providing message 1 during random access.
Method and apparatus for a device to receive a PRDCH providing message 2 from a burst of PRDCH transmissions providing message 2 in response to a PDRCH transmission providing message 1 during random access.
Method and apparatus for a device to receive a PRDCH providing message 2, indicating a request for certain data or a command, and transmit PDRCH providing message 3 during random access.
Method and apparatus for defining a time unit for timing indication and a device to determine a PDRCH transmission timing.
Method and apparatus for a device to determine a PRDCH chip length.
Method and apparatus for a device to determine a PDRCH chip length.

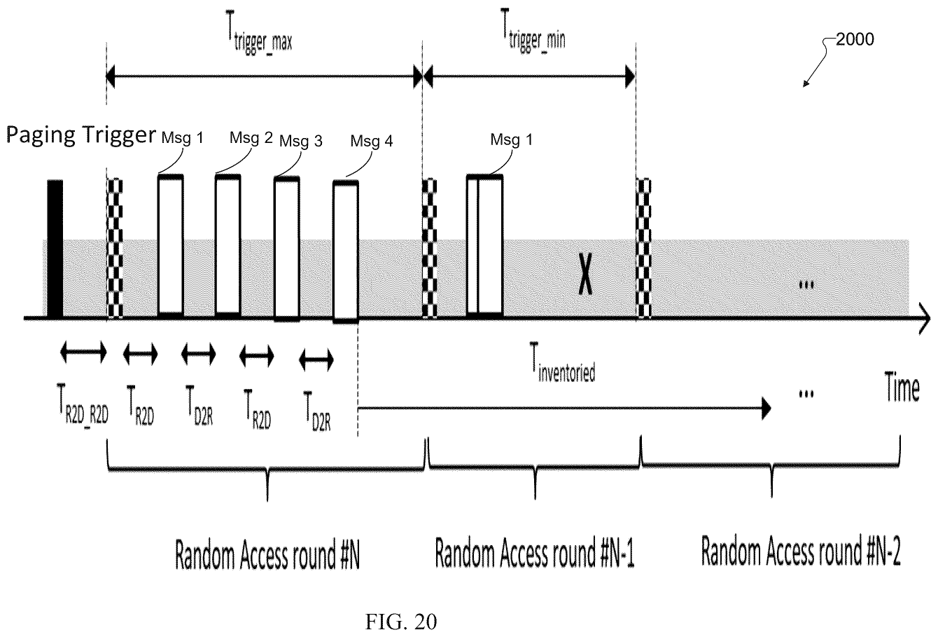

FIG. 20 illustrates a timeline 2000 for an example sequential identification process according to embodiments of the present disclosure. For example, timeline 2000 for an example sequential identification process can be followed by any of the readers described herein and any of the devices described herein. This example is for illustration only and other embodiments can be used without departing from the scope of the present disclosure.

With reference to FIG. 20, an example sequential device identification process via random access according to the disclosure is shown.

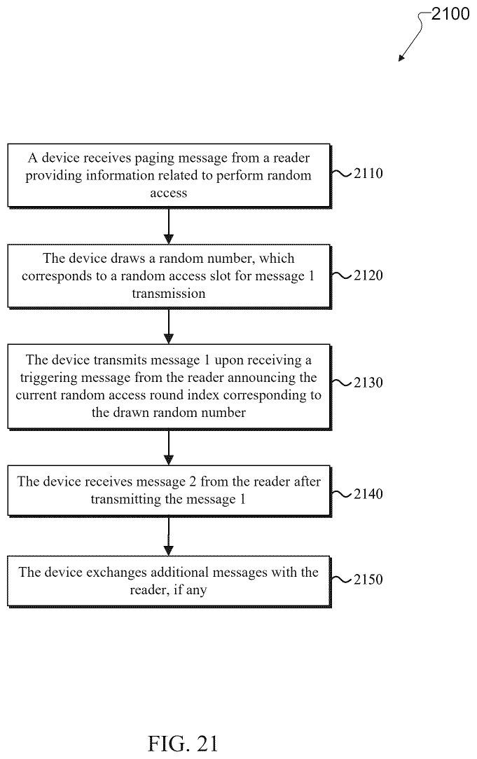

FIG. 21 illustrates a flowchart of an example device procedure 2100 for performing random access according to embodiments of the present disclosure. For example, procedure 2100 can be performed by any of the devices described herein. This example is for illustration only and other embodiments can be used without departing from the scope of the present disclosure.

The procedure begins in 2110, a device receives paging message from a reader providing information related to perform random access. In 2120, the device draws a random number, which corresponds to a random access slot for message 1 transmission. In 2130, the device transmits message 1 upon receiving a triggering message from the reader announcing the current random access round index corresponding to the drawn random number. In 2140, the device receives message 2 from the reader after transmitting the message 1. In 2150, the device exchanges additional messages with the reader, if any.

With reference to FIG. 21 illustrates an example flowchart for a device to perform random access according to the disclosure is shown.

Random access for inventory is initiated by a reader transmitting a page in message and a device receiving the page in message.

The paging message includes device ID for target device identification and information related to determine the resources to be used for the following message 1 transmission. As an example, the paging message can include one or more of:
Inventory procedure type, e.g., whether it is a full-step procedure or a reduced procedure such as four-step or two-step.
   For the 4-step random access, whether the message 4 is expected or not.
Reader ID which can be uniquely identify the reader, e.g., a reader device ID, a random number, or a Cell ID.
Reader device type, whether it is a gNB based reader or a UE based reader.
An ID for identifying the legitimate paging message such as an operator ID, e.g., to distinguish a reader from an operator from another reader from another operator.
Parameters related to power control: transmission power of a message 1 preamble or any pathloss reference signal, target reception power, pathloss scaling factor, a power ramping step in dB for re-attempts.
Parameters related to random access resource configuration
   A number of time slots for random access, whose duration is predefined in the specifications of system operation or indicated in the triggering message.
   A frequency domain resources. In one example, it can be a number of frequency domain resources, wherein the resource can be a sub-carrier, a PRB, a unit frequency amount, or frequency ranges. As an example, a device may randomly select a frequency resource from the number of resources. In another example, it can be a number of frequency shifts, wherein the shifts can be indicated by ±Δ Hz, ±integer multiples of a unit amount of a frequency, or a parameter of a line code, such as a number of subcarrier cycles per symbol.
   There may be an indication of available or prohibited time slots/frequency resources/shifts for random access, e.g., using a mask or a bitmap of a size equal to the number of time slots. The mask/bitmap may be provided separately for each frequency resource/shift, or commonly.
Preamble sequence: If more than one preamble pattern is supported, it can indicate information related to preamble sequence that can be used for PDRCH for the message 1 transmission. The indication may include a dedicated root sequence index for the preamble. The indication may include one or more dedicated preamble index(es). In one example, preamble indexes are indicated for respective devices addressed by the paging message.
Parameters related to random access
   Medium access probability, which may be applied for the given time slots, or per time slot in an individual manner. In one example, the access probability may be 1.
Parameters related to identifier to include in PDRCH transmission. In one example, parameters are related to random number generation such as an interval to draw a random number, e.g., [0, 2^{N}−1], wherein N is indicated. In another example, indication is provided for a type of identifier, such as device product code, e.g., product code (PC), extended product code (XPC), electronic product code (EPC), or a random number, and such as full format or a shortened format. In one example, more than one N values are indicated, one for a certain device group and another one for another device group. In this manner, a prioritized device identification can be performed by a device group indicated a smaller value of N.
Parameters related to PDRCH
   Transmission duration, e.g., in number of symbols or chips, payload size
   Frequency resources such as a particular sub-carrier, PRB, or frequency range for transmission. In another example, a particular frequency shift amount for UL transmission such as by ±Δ Hz, ±integer multiples of a unit amount of a frequency, or a parameter of a line code, such as a number of subcarrier cycles per symbol.
   MCS or a parameter of a line code, such as a number of subcarrier cycles per symbol.
   Attachment of preamble, midamble, postamble, and their format, e.g., long or short format, if more than one formats are supported.
   Attachment of CRC, and/or CRC size.
   Modulation type such as OOK-1, OOK-4, BPSK, QPSK, FSK, ASK with orders.
   Coding type such as indicator for Manchester coding, FM0, or Miller coding.
Parameters related to device selection
   A particular device ID, or a list of device IDs.
   A particular device group ID
      A device may be assigned with a unique device group ID, apart from a device ID.
      A device ID may be comprised of two parts; first part a device group ID and second part a device ID within the group. In this case, the first part of the device ID is indicated.
      mod (device ID, K)=L. In this case, K and L are indicated. In one example, L is fixed, e.g., zero, and only K is indicated.
   All devices, e.g., by indicating NULL or some predefined codepoint for addressing the target device or device groups in the PRDCH transmission. Indicating NULL implies that the message does not contain an ID.
Other parameters
   Maximum number of allowed random access transmissions
   Response monitoring window after transmitting the random access
   Prohibit timer after a failed random access attempt
   Allowance of UL power amplification
   System/channel/occupied BW
   Sub-carrier spacing
   Parameters related to the carrier wave (CW), e.g., CW bandwidth, frequency, single-tone or multi-tone. PRDCH to CW power offset.

4-step random access is comprised of the following steps:
A-IoT message 1 (Msg1): the device sends an ID to the reader. Fixed random ID size of 16 bit is used. The ID is randomly generated.
A-IoT message 2 (Msg2): the reader echoes the ID received in Msg1. Msg3 transmission resource can explicitly be indicated in Msg2.
A-IoT message 3 (Msg3): device sends Device ID and/or any other upper layer data (depending on upper layer request)
A-IoT message 4 (Msg4): the subsequent R2D transmission after D2R transmission, which does not need to be sent in random access. “Msg4” can be taken into account to handle the Msg3 transmission failure (due to various reasons).

In one example, the reader assigns an ID to the device, different from the random ID used in the previous steps, in message 2 or message 4 for the purpose of addressing the identified device for subsequent communication with the reader. In another example, when the device receives message 2 confirming its random ID in message 1, the device assumes that the random ID is automatically promoted to an assigned ID, which can be used for subsequent communication with the reader.

The Msg4 may or may not be present; therefore the random access may be compromised of three steps. However, in this disclosure, it is also referred to as 4-step random access.

If the paging message is addressed to one or more targeted devices with dedicated resources, the message 1/2 is skipped and the device directly transmits message 3 upon receiving the paging message. The device ID included in the message 3 can be a random ID that the device already exchanged with and confirmed from a reader or the ID is associated with the device itself, such as EPC, XPC and PC.

2-step random access is comprised of the following steps:
A-IoT Msg1: The device sends Device ID and/or any other upper layer data (depending on upper layer request). Fixed random ID size of 16 bit is used. The ID is randomly generated.
A-IoT Msg2: the reader may echo some information from Msg1.

A device randomly decides to transmit the message 1, and potentially transmit the message 1 following a triggering message reception. The first trigger message follows the paging message transmission in a time interval [T_{R2D_R2D_min}, T_{R2D_R2D_max}]. In one example, for the very first random access round, the triggering message transmission is skipped, and the paging message serves the purpose of the first triggering message. In one example, the time interval between two adjacent triggering messages are fixed, which is denoted by T_{trigger}. In another example, the next triggering message can follow the previous triggering message in a certain time interval denoted by [T_{trigger_min}, T_{trigger_max}]. In yet another example, a triggering message indicates the transmission timing of the one or more next subsequent triggering messages. In one example, the message 4 transmission can serve the purpose of the next triggering message. Therefore, there is no separate triggering message transmission and devices can transmit message 1 following the message 4 in the time interval [T_{R2D_min}, T_{R2D_max}]. Similarly, for the 4-step random access, the message 2 can serve the purpose of the next triggering message.

The triggering message, including any other signal that can serve the purpose of triggering message such as paging, message 2 or message 4, can provide one or more of the followings:
Any information from the list of information disclosed for the paging message.
Any information provided in the paging message, which is repeated or an update to the previously indication in the paging.
Remaining or the current triggering message count, e.g., N, N-1, N-2, . . . .
Transmission timing of the one or more next subsequent triggering messages
List of identified device IDs in the previous round. This serves as an acknowledgement, as well as the identified devices can skip the subsequent random access rounds of the inventory process.
Remaining time until the end of the current inventory process or the start of next new inventory/command process. A device, which has successfully finished the random access, is not required to monitor R2D signal or expected to transmit D2R signal during the indicated remaining time.
Parameters for facilitating the sleep state, e.g., the maximum and the minimum time between the triggering messages, and the sleep timer for devices already checked in. The sleep timer may be broadcasted, which applies to the devices which already have checked in. Alternatively, the timer may be specifically indicated to a specific device ID.

In the sequential device identification process via random access, device identification is performed for at most one device in one random access round. The figure is illustrated for time domain operation. It can be understood that the operation can be both in time and frequency domain, i.e., the message 1 transmission may involve a random time/frequency resource selection. Furthermore, the message 1 transmission may further involve a selection for the preamble signal from the set of allowed preamble signals.

The message 1 transmission may follow the preceding trigger message in time interval [T_{R2D_min}, T_{R2D_max}]. Alternatively, the message 1 transmission timing is indicated in the trigger message. The message 2 may follow the preceding message 1 transmission in time interval [T_{D2R_min}, T_{D2R_max}]. The subsequent message 3 transmission may follow the preceding message 2 transmission in time interval [T_{R2D_min}, T_{R2D_max}]. Alternatively, the message 3 transmission timing is indicate in the message 2. The subsequent message 4 transmission may follow the preceding message 3 transmission in time interval [T_{D2R_min}, T_{D2R_max}]. The message 4 may or may not be transmitted.

The 2-step random access can be understood from FIG. 19 which only involves message 1 and message 2 transmission in each round.

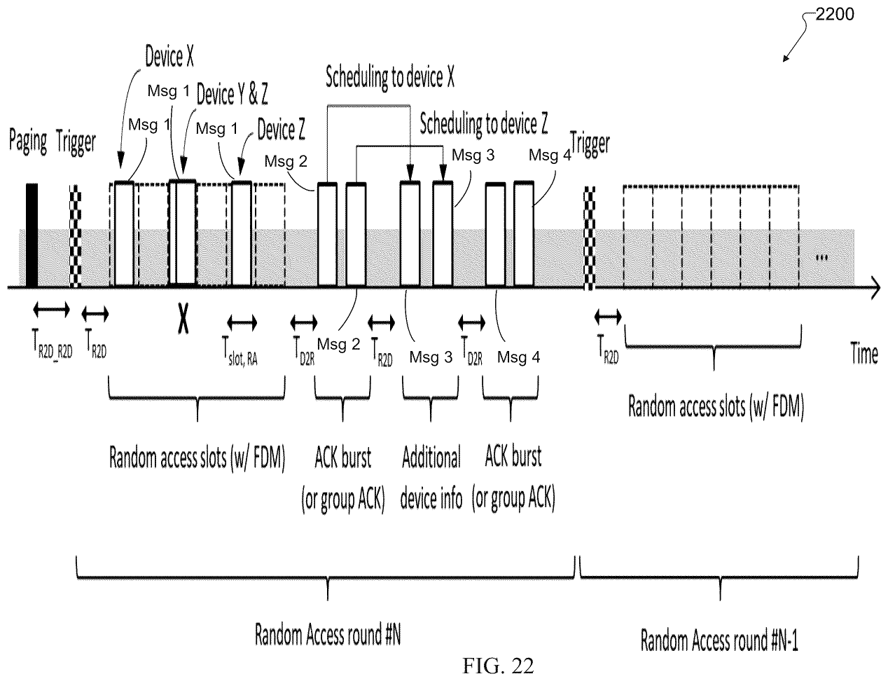

FIG. 22 illustrates a timeline 2200 of an example multiplexed identification process according to embodiments of the present disclosure. For example, timeline 2200 can be followed by any of the readers described herein and any of the devices described herein. This example is for illustration only and other embodiments can be used without departing from the scope of the present disclosure.

With reference to FIG. 22, an example multiplexed device identification process via random access according to the disclosure is shown. Any details disclosed for the sequential identification process can be also applicable for the multiplexed device identification process as well.

The random access from multiple devices occurs in a burst manner over a number of consecutive time slots. In one example, the length of each time slot includes D2R transmission duration for random access and guard time. In another example, the length of each time slot is equal to D2R transmission duration for random access, and there is a separate guard time provided between time slots. In yet another example, the reader transmits a certain timing reference signal, e.g., preamble, synchronization signal, etc., in the beginning of each time slot, and the D2R transmission for random access follows after a certain time interval, e.g., [T_{R2D_min}, T_{R2D_max}].

In one example, one or multiple time instances are indicated in the paging message or in the trigger message. The interval between two consecutive time instances may be fixed. In this example, a number of time instances are indicated to the devices. The start of the first time instance may be indicated or predefined in the specifications of the system operation, e.g., T_{R2D_min} or T_{R2D_max} from the triggering or paging message reception. In another example, the interval between two consecutive time instances are not fixed. For instance, the time interval increases for time instances later in time. This increased interval is to accommodate a timing drift of a device from the reception of a paging or a trigger message.

For the one or multiple indicated time instances, a device attempts to transmit at the indicated time instances according to the random decision for accessing. In another example, for the one or multiple indicated time instances, a device attempts to transmit within a certain margin, e.g., [−Δ₁, Δ₂] wherein Δ₁ and Δ₂ can be the same or different, at the indicated time instances according to the random decision for accessing. In yet another example, for the one or multiple indicated time instances, a device attempts to transmit within a certain time interval, e.g., [Δₓ, Δₓ] wherein Δₓ and Δ_{y} can be T_{R2D_min} and T_{R2D_max} as an example, from the indicated time instances according to the random decision for accessing.

In one example, the message 2 is provided individually for each successfully received message 1 in a burst manner. When one or more message 2 are transmitted in a burst manner, there may be a time gap, e.g., T_{R2D_R2D}), between the transmissions. Alternatively, there may be no time gap between the consecutive ACK transmissions. In another example, a group message is provided for a number of successfully received message 1 from the preceding one or more random access slots. The group message includes a number of message 2s in one transmission for one or multiple devices who message 1 transmission is successfully received at the reader.

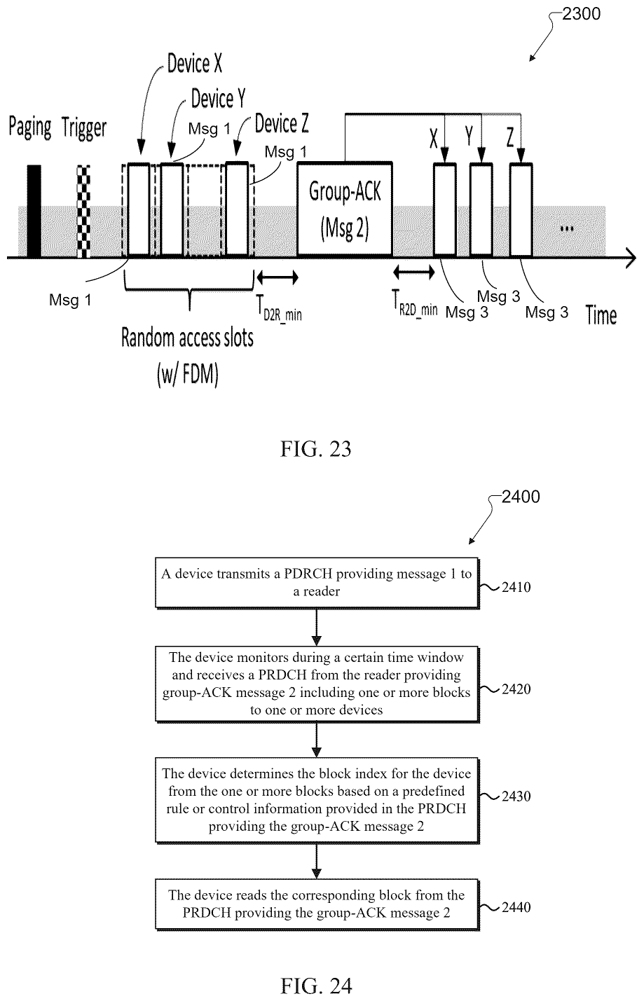

FIG. 23 illustrates a timeline 2300 of an example Msg 2 group-acknowledgement (ACK) transmission according to embodiments of the present disclosure. For example, timeline 2300 can be followed by any of the readers described herein and any of the devices described herein. This example is for illustration only and other embodiments can be used without departing from the scope of the present disclosure.

With reference to FIG. 23, an example Msg 2 group-ACK transmission corresponding to multiple Msg Is according to the disclosure. The illustrated random access slots need not be consecutive. They can be disjoint and further associated with respective triggers. Although the figure is illustrated for the purpose of illustration providing 3-step random access. However, it is noted that any embodiment disclosed herein can be applicable for 2-step random access or 4-step random access.

FIG. 24 illustrates a flowchart of an example device procedure 2400 for receiving a PRDCH according to embodiments of the present disclosure. For example, procedure 2400 can be performed by any of the devices described herein. This example is for illustration only and other embodiments can be used without departing from the scope of the present disclosure.

The procedure begins in 2410, a device transmits a PDRCH providing message 1 to a reader. In 2420, the device monitors during a certain time window and receives a PRDCH from the reader providing group-ACK message 2 including one or more blocks to one or more devices. In 2430, the device determines the block index for the device from the one or more blocks based on a predefined rule or control information provided in the PRDCH providing the group-ACK message 2. In 2440, the device reads the corresponding block from the PRDCH providing the group-ACK message 2.

With reference to FIG. 24, an example flowchart is shown for a device to receive a PRDCH providing group-ACK (Msg 2) according to the disclosure.

In one example, a device expects to receive a group-ACK (Msg 2) after a certain time gap from the end of the random access slots, i.e., from the end of the last slot as illustrated in the figure. The time gap may be predefined in the specifications of a system operation or indicated to the device. In one example, the time gap is T_{D2R_min}.

In another example, there is a monitoring window defined such that a device monitors a possible group-ACK for a time interval of [T₁, T₂] from the end of the last random access slot. The parameters T₁, T₂ may be predefined in the specifications of a system operation or indicated to the device in the paging or a trigger message. In one example, T₁, T₂ corresponds to T_{D2R_min}, T_{D2R_max}, respectively.

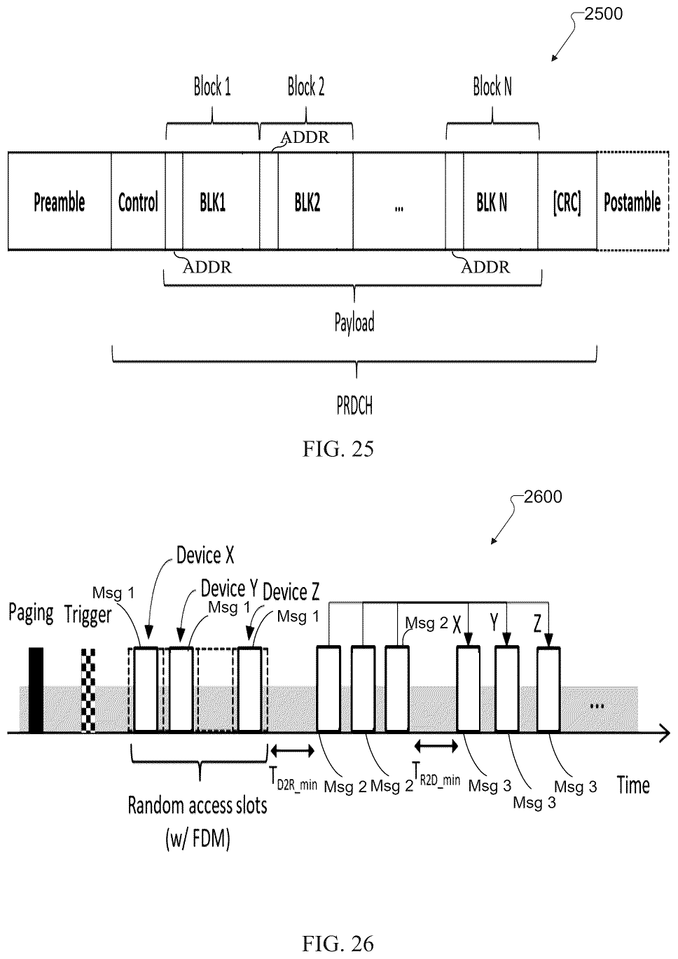

FIG. 25 illustrates an example PRDCH 2500 according to embodiments of the present disclosure. For example, PRDCH 2500 can be received by any of the devices described herein. This example is for illustration only and other embodiments can be used without departing from the scope of the present disclosure.

With reference to FIG. 25, an example PRDCH providing a group-ACK (Msg 2) according to the disclosure is shown.

In the PRDCH providing a group-ACK (Msg 2), an acknowledgement to one or more Msg 1 transmissions from one or more devices are provided.

Any device determines the location of a block for the device in the PRDCH providing a group-ACK (Msg 2) in one of the following manner:
There is a fixed association between the random access resource and the location of the block in the PRDCH providing a group-ACK (Msg 2). In one example, the length of each block is fixed and predefined in a specification of a system operation. Therefore, by having the block index a device can locate the starting position of the corresponding block within the PRDCH providing a group-ACK (Msg 2).
   If the random access resource is comprised of a number of time slots, K, as illustrated in the figure, for a device transmitted Msg 1 in the k-th slot has a block index k in the PRDCH providing a group-ACK (Msg 2).
   If the random access resource is comprised of a number of frequency resources/shifts, J, for a single transmission occasion, for a device transmitted Msg 1 in the j-th frequency resource/shift has a block index j in the PRDCH providing a group-ACK (Msg 2).
   If the random access resource is comprised of a number of time slots, K, and a number of frequency resources/shifts, J, for a device transmitted Msg 1 in the k-th slot and in the j−th frequency resource/shift has a block index (k−1)·J+j. This is just an example and similar approaches should be regarded as a variant of this method.
      As one variant, there can be a notion of subgrouping of the blocks such that every J blocks are grouped into one level. Therefore, the block index for the example herein is given by (k, j).
   There may be additional resource domain, such as code domain. The same principle as described herein applies in a similar manner.
A block index for a device is provided in the PRDCH providing a group-ACK (Msg 2).
   In one example, the control information in the PRDCH provides a list of random IDs successfully received in the message 1 receptions. An index of a random ID of the device from the list of random IDs provided in the control information corresponds to the block index for the device to locate its block in the PRDCH providing a group-ACK (Msg 2). For instance, if the random ID used by the device is found in the n-th entry from the list of random IDs provided in the control information, then the block index for the device is n.
   In another example, as illustrated in the figure, each block provides an header providing the address field, where the address field provides the random ID received in the Msg 1 reception. A device searches through the blocks to find a matching random ID in the addressed field that it used for the Msg 1 transmission, which is the block for the device.

FIG. 26 illustrates a timeline 2600 of example burst Msg 2 transmissions according to embodiments of the present disclosure. For example, timeline 2600 can be followed by any of the readers described herein and any of the devices described herein. This example is for illustration only and other embodiments can be used without departing from the scope of the present disclosure.

With reference to, FIG. 26, an example burst Msg 2 transmissions corresponding to multiple Msg Is according to the disclosure. The illustrated random access slots need not be consecutive. They can be disjoint and further associated with respective triggers. Although the figure is illustrated for the purpose of illustration providing 3-step random access. However, it is noted that any embodiment disclosed herein can be applicable for 2-step random access or 4-step random access.

In FIG. 26, a PRDCH provides a single Msg 2 which corresponds to a single Msg 1 reception in a burst manner. Any details disclosed for the group-ACK can be also applicable for the burst ACK transmission.

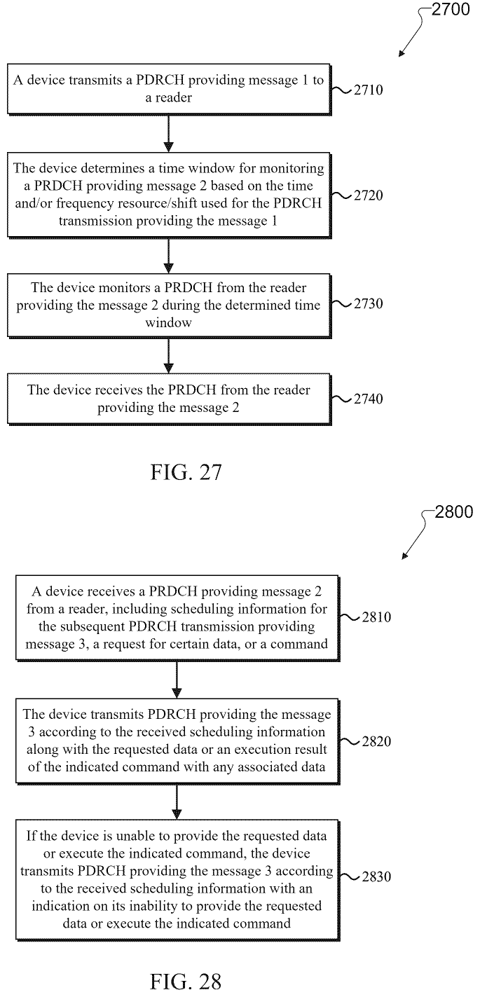

FIG. 27 illustrates a flowchart of an example device procedure 2700 for receiving a PRDCH according to embodiments of the present disclosure. For example, procedure 2700 can be performed by any of the devices described herein. This example is for illustration only and other embodiments can be used without departing from the scope of the present disclosure.

The procedure begins in 2710, a device transmits a PDRCH providing message 1 to a reader. In 2720, the device determines a time window for monitoring a PRDCH providing message 2 based on the time and/or frequency resource/shift used for the PDRCH transmission providing the message 1. In 2730, the device monitors a PRDCH from the reader providing the message 2 during the determined time window. In 2740, the device receives the PRDCH from the reader providing the message 2.

With reference to FIG. 27, an example flowchart is shown for a device to receive a PRDCH providing message 2 according to the disclosure.

A device monitors the PRDCH providing Msg 2 in one of the following example manners:
There is a monitoring window defined such that the device, who transmitted Msg 1, monitors a possible Msg 2 intended to the device from the burst Msg 2 transmissions in a time interval [T₁, T₂] from the end of the last random access slot.
   In one example, T₁, T₂ corresponds to T_{D2R_min}, T_{D2R_max}, respectively.
   In another example, T₁, T₂, or both T₁ and T₂ are dependent on the total number of time and frequency resources configured for the random access. For instance, it is predefined such that T₁ corresponds to T_{D2R_min}, while T₂ is determined based on the total number of random access opportunities configured in time and frequency. In principle, T₂ increases with the total number of random access opportunities.
In another example, each random access time slot is associated with a separate monitoring window, which may or may not overlap with each other.
   Each random access time slot i is associated a monitoring window, [T_{i,1}, T_{i,2}] from the end of the last random access slot or from the end of time slot i.
   The length of the monitoring window can be dependent on the number of frequency resources/shifts configured for each time resource. For instance, T_{i,2}-T_{i,1} increases with the number of frequency resources/shifts.
   As an example, the monitoring window associated with the first random access time slot is defined from the end of the last random access time slot as [T_{offset}, T_{offset}+W], where T_{offset} is the start offset from the end of the last random access time slot, which may be T_{D2R_min} and W is the monitoring window length. Then, the monitoring window associated with the n-th random access time slot is defined from the end of the last random access times slot as [T_{offset}+ (n−1)·Δ, T_{offset}+(n−1)·Δ+W], where Δ and W may be the same or different.
   When more than one frequency resources/shifts are configured for a given time domain resource, which can be one or multiple, each frequency resource/shift may be associated with a certain offset from the start of the monitor window associated with the given random access time slot. For instance, if the monitoring window for the given random access time slot is given as [T₁, T₂], the monitoring window for the first frequency resource/shift is given the same as [T₁, T₂], while for the second frequency resource/shift, it is given as [T₁+δ, T₂+δ] and so on. In one example, δ is equal to T₂−T₁.

Any of the described parameters herein may be predefined in the specifications of a system operation or indicated to the device in the paging or a trigger message.

FIG. 28 illustrates a flowchart of an example device procedure 2800 for receiving a PRDCH and transmitting a PRDCH according to embodiments of the present disclosure. For example, procedure 2800 can be performed by any of the devices described herein. This example is for illustration only and other embodiments can be used without departing from the scope of the present disclosure.

The procedure begins in 2810, a device receives a PRDCH providing message 2 from a reader, including scheduling information for the subsequent PDRCH transmission providing message 3, a request for certain data, or a command. In 2820, the device transmits PDRCH providing the message 3 according to the received scheduling information along with the requested data or an execution result of the indicated command with any associated data. In 2830, if the device is unable to provide the requested data or execute the indicated command, the device transmits PDRCH providing the message 3 according to the received scheduling information with an indication on its inability to provide the requested data or execute the indicated command.

With reference to FIG. 28, an example flowchart is shown for a device to receive a PRDCH providing message 2 and transmit a PDRCH providing a message 3 according to the disclosure.

Each block of a PRDCH providing a group-ACK (Msg 2), a PRDCH providing a single ACK (Msg 2) from a burst of PRDCHs providing Msg2s, or a normal PRDCH providing a single ACK (Msg 2) can provide one or more of the following information:
Scheduling information for Msg 3 including PDRCH transmission timing and a frequency resource/shift, if applicable. The time unit for the timing indication can be one of the options as described later.
Any data request to be included in the Msg 3.
A command. It is an indication of an index to a certain codepoint from a set of codepoints, wherein each code point corresponds to a certain command type which is predefined in a specification of a system operation.

Also, any of the listed information herein can be provided in the Msg 2 of the 2-step random access wherein in this case the provided information is not intended for Msg 3 but for a PDRCH transmission, which is decoupled from the random access procedure.

If the Msg 2 indicates a device to provide a certain data in the Msg 3, the device includes the requested data in the Msg 3 transmission. If the device is unable to provide the request data, e.g., due to unavailability of the data, processing time shortage, or low energy level, the device indicates in the Msg 3 to the reader that it is unable to provide the requested data.

If the Msg 2 indicates a device to execute a certain command, the device includes the command execution result and associated data, if any, in the Msg 3 transmission. If the device is unable to execute the command, e.g., due to unavailability of the data, processing time shortage, or low energy level, the device indicates in the Msg 3 to the reader that it is unable to execute the requested command.

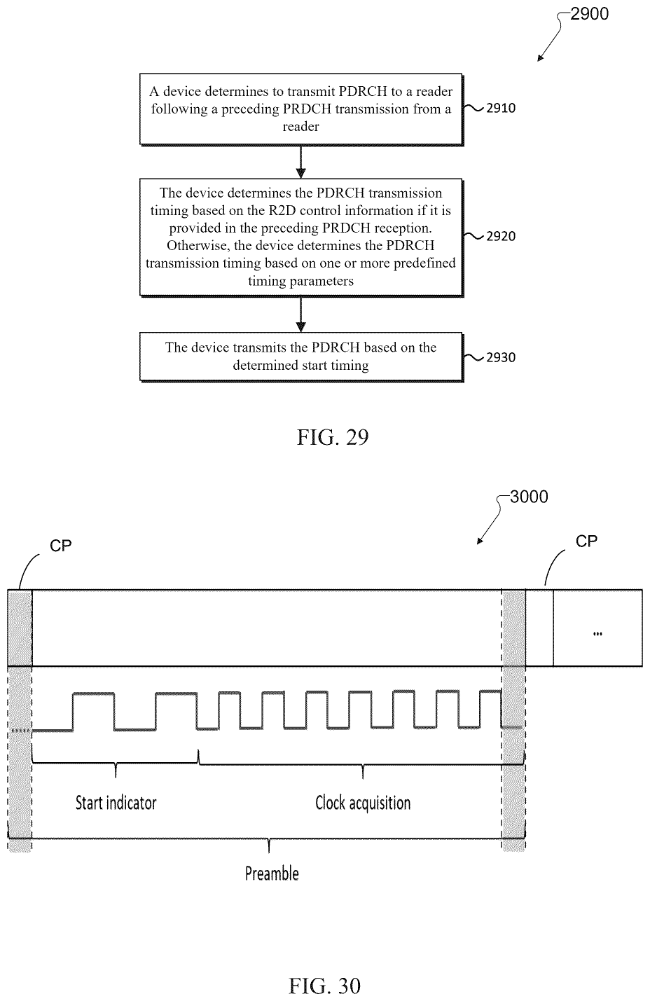

FIG. 29 illustrates a flowchart of an example device procedure 2900 for determining PDRCH transmission timing according to embodiments of the present disclosure. For example, procedure 2900 can be performed by any of the devices described herein. This example is for illustration only and other embodiments can be used without departing from the scope of the present disclosure.

The procedure begins in 2910, a device determines to transmit PDRCH to a reader following a preceding PRDCH transmission from a reader. In 2920, the device determines the PDRCH transmission timing based on the R2D control information if it is provided in the preceding PRDCH reception. Otherwise, the device determines the PDRCH transmission timing based on one or more predefined timing parameters. In 2930, the device transmits the PDRCH based on the determined start timing.

With reference to FIG. 29, an example flowchart is shown of an A-IoT device to determine the PDRCH transmission timing according to the disclosure.

Regarding a device determining D2R transmission timing, one option is to define a maximum time T_{R2D_max} between the end of a R2D transmission and the start of the corresponding D2R transmission following it, and a device randomly selects D2R transmission timing within [T_{R2D_min}, T_{R2D_max}]. In another option, for a given type of PDRCH message, there is a timing parameter, T_{delay}, defined from the end of the reception of the preceding PRDCH to the start timing of PDRCH. In yet another option, the D2R transmission timing is determined based on R2D control information.

When the D2R transmission timing is determined based on R2D control information, e.g., by providing a timing parameter in the R2D control information, a guard time between time-multiplexed devices may be taken into account by the reader taking into account timing drift or processing delay for PDRCH transmission at the devices. In another example, R2D control information may provide a start timing parameter, T, and allowed timing drift, e.g., δ₁, δ₂, such that a device determines PDRCH start timing within [T−δ₁, T−δ₂], wherein δ₁ and δ₂ can be the same. In yet another example, R2D control information may provide a start timing parameter, T, to a device, and the device determines its PDRCH start timing within [T+T_{R2D_min}, T+T_{R2D_max}]. In another example, a device determines its PDRCH start timing within [T, T+T_{R2D_max}−T_{R2D_min}].

For D2R transmissions based on multi-access, the D2R transmission timing is determined based on timing parameter provided in the R2D control information. On the other hand, when a transmission from only a single device is expected, e.g., a response from a device to a targeted command from a reader, the corresponding D2R transmission timing is determined based on predefined timing parameter, such as [T_{R2D_min}, T_{R2D_max}], without an explicit timing indication in R2D control information.

When R2D control information provides a start timing parameter, T, for the D2R transmission, the time unit for the indication can be one of the followings:
The time unit for the indication is the minimum chip length supported in the system, which corresponds to the largest OOK-4 M value defined to be supported in the specifications of a system operation. In one example, if the largest value of M supported in the system is denoted by Mₘₐₓ, then the time unit for the D2R transmission timing indication is (1/Mₘₐₓ)·T_{symbol}, where T_{symbol} is an underlying CP-OFDM symbol duration. In one example, the T_{symbol} does not include the CP duration. In one example, the T_{symbol} is based on 15 kHz subcarrier spacing or 30 kHz subcarrier spacing. For 15 kHz subcarrier spacing, T_{symbol} is 66.67 μs. In one example, the maximum M value, Mₘₐₓ, supported in the system is 16, 24, or 32. For example, if Mₘₐₓ equals to 16, the time unit for the D2R transmission indication is given by 4.167 μs according to the formula described herein.
The time unit for the indication is the time duration to transmit 1 bit expecting minimum chip length supported in the system, which corresponds to the largest OOK-4 M value defined to be supported in the specifications of a system operation. For the case when Manchester encoding is used, two chips are required to represent one bit. Therefore, the time duration for indication can be. 2·(1/Mₘₐₓ)·T_{symbol}. These can be generalized to N_{chip}·(1/Mₘₐₓ)·T_{symbol}, where N_{chip} is the number of chips required to represent a bit for a given encoding scheme. Examples describe for the previous case can be similarly applicable.
The time unit for the indication is the chip length, which corresponds to M value, used for the PRDCH indicating the D2R transmission timing. Examples describe for the previous case can be similarly applicable.
The time unit for the indication is the chip length, which corresponds to M value, indicated for the transmission of the PDRCH by the scheduling PRDCH control field. Examples describe for the previous case can be similarly applicable.
The time unit for the indication is the time duration to transmit 1 bit expecting the chip length, which corresponds to M value, used for the PRDCH indicating the D2R transmission timing. Examples describe for the previous case can be similarly applicable.
The time unit for the indication is the time duration to transmit 1 bit expecting the chip length, which corresponds to M value, indicated for the transmission of the PDRCH by the scheduling PRDCH control field. Examples describe for the previous case can be similarly applicable.
The time unit for the indication is based on the underlying CP-OFDM symbol duration for a given subcarrier spacing. The unit can be one or multiple OFDM symbol durations, e.g., 2, 4, 6, 8, 10, 12, or 14. In one example, the OFDM symbol duration does not include the CP length. In another example, the OFDM symbol duration includes the CP length. For 15 kHz subcarrier spacing, if the symbol duration does not include the CP duration, then the time unit is given by 66.67 μs. If the symbol duration includes the CP duration, the time unit is given by (5.21+66.67) μs for the 0^{th} and 7^{th} OFDM symbol and it is (4.69+66.67) μs for the rest of symbols. In one example, an average CP duration is expected for an OFDM symbol duration such that (5.21+6*4.69)/7=4.76 μs is the expected CP duration. Therefore, an OFDM symbol duration, which is the time unit for the indication, is expected to be (4.76+66.67) μs.
The time unit for the indication is based on the slot duration expecting underlying CP-OFDM subcarrier spacing. The unit can be one or multiple slot durations. For 15 kHz subcarrier spacing, the slot duration is given by 1 ms.
The time unit for the indication is based on us or ms.
There is a table predefined in a specification of a system operation which defines a set of timing values. For instance, up to 2^{N} timing values can be predefined, and a device is indicated one codepoint using N bit indication in the PRDCH control field.

In one example, the indicated scheduling timing for D2R transmission, T, cannot be earlier than the minimum timing between a R2D transmission and a D2R transmission following it, i.e., T≥T_{R2D_min}. In one example, a device may be allowed to transmit at the indicated timing T with a certain timing margin [T−δ₁, T+δ₂] from when the scheduling R2D is received, where δ₁, and δ₂, are positive real number. In one example, δ₁ and δ₂ are the same. The parameters δ₁, and δ₂ may be predefined in a specification of a system operation or indicated to the device from a reader. If indicated, the time unit for the indication can be one of the options described herein.

While a device may transmits at an exact timing from the device perspective, there can be an uncertainty on the actual transmission timing due to timing drift due to device's SFO. Therefore, the reader may need to account a certain time interval for detecting the D2R transmission. In one example, a reader monitors the scheduler D2R transmission in the time range of [T−Δ₁, T+Δ₂], wherein Δ₁, Δ₂ are positive real numbers and they can be the same or different, from when the scheduling R2D message was transmitted. In one example, Δ₁ is greater than or equal to δ₁. Similarly, Δ₂ is greater than or equal to δ₂. The parameters Δ₁, and Δ₂ may be predefined in a specification of a system operation or indicated to the reader from a gNB (e.g., the BS 102), if it is a UE-based reader. If indicated, the time unit for the indication can be one of the options described herein.

As described in FIG. 18, the preamble includes a start-indicator part and a clock-acquisition part.

The clock acquisition part can be a sequence transmitted in time domain providing timing synchronization for the demodulation of the following fields, such as header and payload. It may be also used for channel estimation and setting up the automatic gain control (AGC), etc. The design of clock acquisition part will be dependent on the used encoding schemes. For instance, in the case of PIE encoding, the clock acquisition part needs to provide a calibration for signal pulse durations for bit 0 and 1, as bit 1 has different pulse duration than bit 0. In the case of Manchester encoding, the clock acquisition part can be comprised of a sufficient number of alternations between 0 and 1 for providing a synchronization, while the signal for bit 0 and 1 has a fixed length. In one example, the clock-acquisition part is an encoded signal of 10101010. In another example, the clock acquisition part is a pattern comprised of 0 and 1, i.e., low and high voltage states, and it is not necessarily an alternation between 0 and 1.

FIG. 30 illustrates an example preamble signal structure 3000 according to embodiments of the present disclosure. For example, preamble signal structure 3000 may be transmitted by any of the devices described herein. This example is for illustration only and other embodiments can be used without departing from the scope of the present disclosure.

With reference to FIG. 30, an example preamble design occupying one or more symbol durations according to the disclosure is shown.

In the figure, it is exemplified that the entirety of the preamble signal occupies one OFDM symbol duration. In another example, the preamble signal is designed such that it occupies an integer number of OFDM symbol durations. In yet another example, each of the start-indicator and the clock acquisition parts occupy one or more OFDM symbol durations.

In one embodiment, the clock acquisition part is one symbol long, i.e., the number of chips in the clock part is M for a chosen M value. The resulting M chips from a chosen clock acquisition sequence has a property such that the 1^{st} chip and the M^{th} chip has the same value and, therefore, the added CP does not incur any false edges. In another embodiment, the clock acquisition sequence is designed such that the last chip, i.e., M^{th} chip, has a value {0} such that the CP attachment only extends the length of the low voltage start indicator part and does not incur any false edges creating an invalid chip.

In another embodiment, the number of chips in the clock acquisition part, L, is an integer multiple of a set of M values supported in the system. As an example, if M={2, 4, 8} is supported, L can be 8, 16, . . . , etc. The resulting L chips from a chosen clock acquisition sequence has a property such that, when L chips are segmented into one or more groups of M chips for a value of M supported in the system, the 1^{st} chip and the M^{th} chip in each group has the same value and, therefore, the added CP does not incur any false edges.

In one example, the start indicator part has a fixed length comprised of a fixed number of chips, expecting a fixed M value. The expected fixed M value for the start indicator part can be 2, 4, or 8. In another example, the start indicator part has a fixed number of chips expecting the same M value used for the following clock acquisition part. Therefore, the length of the start indicator part decreases as the M increases. In yet another example, both the number of chips and the M value for the start indicator part is associated with the M value used for the following clock acquisition part. For instance, both the number of chips and the M value for the start indicator part are the same with the M value expected to generate chip rate/duration for the following clock acquisition part.

In one example, the clock acquisition part has a fixed length, while the used M value for the clock acquisition part is not fixed. As the clock acquisition part can be used to determine the OOK chip duration for the following PRDCH, the M value used for the clock acquisition part is linked to the M value used for the following PRDCH, at least for the control part or both the control and the payload parts of the PRDCH. Therefore, the total number of chips comprising the clock acquisition part is variable according to the M value. As an example, if the length of the clock acquisition part is one OFDM symbol long and the used M value is 32, then the number of chips included in the clock acquisition part is also 32. Similarly, if the used M value is 16, then the number of chips included in the clock acquisition part is also 16. In this case, if the preamble includes both the start-indicator part as well as the clock acquisition part, the length of the preamble is also fixed.

In another example, the clock acquisition part is comprised of a fixed number of chips, while the used M value for the clock acquisition part is not fixed as the M value used for the clock acquisition part is linked to the M value used for the following PRDCH as described herein. Therefore, the length of the clock acquisition part is variable, and it is inversely proportional to the value of M. As an example, the fixed number of chips included in the clock acquisition part is 4, 8, 16, or 32. If the fixed number of chips included in the clock acquisition part is 16 and the used M value is also 16, then the clock acquisition part occupies one OFDM symbol duration. If the fixed number of chips included in the clock acquisition part is 16 and the used M value is also 8, then the clock acquisition part occupies two OFDM symbol duration. Similarly, if the fixed number of chips included in the clock acquisition part is 16 and the used M value is also 32, then the clock acquisition part occupies half OFDM symbol duration.

In yet another example, both the number of chips comprised in the clock acquisition part and the length of the clock acquisition part are not fixed. The principle here is that the number of chips included in the clock acquisition part decreases with value of M, but not as fast as the first example by the factor of M. Therefore, the length of the clock acquisition part decreases as the value of M increases but neither it is fixed nor it decreases as fast as the second example. As an example, the number of chips comprising the clock acquisition part is given by α(M)·M, where α(M) is predefined in a specification of a system operation. As an example, α(M) is predefined as

$$\begin{matrix}α ( M ) = 3 / 2 for M \leq 8 \\ α ( M ) = 1 for M = 16 \\ α ( M ) = 3 / 4 for M = 32\end{matrix}$$

The example herein should be understood as one example based on the described principle.

If PRDCH includes or is attached with any of a midamble or a postamble, the midamble/postamble has a fixed length comprised of a fixed number of chips, expecting a fixed M value. In another example, the midamble/postamble has a fixed number of chips expecting the same chip rate/duration (or M value) used for the clock acquisition part in the preceding preamble. Therefore, midamble/postamble has a variable length which is inversely proportional to the expected M value. In yet another example, the midamble/postamble has a fixed duration while the same chip rate/duration (or M value) used for the clock acquisition part in the preceding preamble is expected. Therefore, the number of chips in the midamble/postamble increases with the expected M value.

In yet another example, the midamble or the postamble has the same pattern, including the number of chips, chip rate/duration, and the total duration, as the preceding clock acquisition part of the preamble.

In one example, the postamble has the same pattern, including the number of chips, chip rate/duration, and the total duration, as the preceding start indicator part of the preamble.

A device determines the OOK chip rate/length to be used for the PDRCH in one of the following manner:
The chip rate/length to be used for the PDRCH is the same as the preceding PRDCH triggering or scheduling the corresponding PDRCH.
The chip rate/length to be used for the PDRCH is indicated in the control information of the preceding PRDCH triggering or scheduling the corresponding PDRCH.
   In one example, the control information of the preceding PRDCH indicates the modulation scheme, such as OOK-1 or OOK-4 and the M value for the OOK-4.
   In one example, the control information of the preceding PRDCH indicates the chip rate/length to be used for the PDRCH in relation to the chip rate/length used for the corresponding PRDCH. In one example, with no indication, the chip rate/length to be used for the PDRCH is the same as the preceding PRDCH triggering or scheduling the corresponding PDRCH. In another example, it is indicated to be half of the chip rate, i.e., half of the M value or doubled chip length, of the preceding PRDCH triggering or scheduling the corresponding PDRCH. For instance, the indicated ratio to the preceding PRDCH chip rate can be 4, 2, 1 (the same), ¾, ½, or ¼. In one example, the maximum ratio that can be indicated is 1 (the same).
   In any of the examples herein, the device may receive a separate indication for the control/header part and the payload part of the PDRCH, respectively. Alternatively, the device may receive a single indication, which applies to both the control/header part and the payload part of the PDRCH.

The disclosure relates to a communication system. The disclosure relates to defining functionalities and procedures for communication with A-IoT devices which may be lacking a precise timing capability and have a limited operation time due to energy harvesting.

The disclosure also relates to defining functionalities and procedures for preventing a duplicated response from a device by providing an information related to exclusion.

The disclosure also relates to defining functionalities and procedures for defining time division multiple access (TDMA) time slots for Msg1 transmission via random access.

The disclosure also relates to defining functionalities and procedures for a device for determining a random access round from a number of rounds and a random access resource from a number of resources.

The disclosure also relates to defining functionalities and procedures for a device for monitoring PRDCH providing Msg2 following Msg1 transmission, when a PRDCH for Msg2 transmission corresponds to a A-IoT Msg1 received from one device or when a PRDCH for Msg2 transmission corresponds to multiple A-IoT Msg1 received from different devices.

The disclosure also relates to defining functionalities and procedures for a device for receiving PRDCH providing Msg2 when a PRDCH for Msg2 transmission corresponds to multiple A-IoT Msg1 received from different devices.

The disclosure also relates to defining functionalities and procedures for a device for transmitting PDRCH providing Msg3 following a Msg2 reception, wherein the Msg3 is transmitted in a TDMA/FDMA manner.

Embodiments of the disclosure for communication with A-IoT devices, which may be lacking a precise timing capability and have a limited operation time due to energy harvesting, are summarized in the following and are fully elaborated further herein.
Method and apparatus to prevent a duplicated response from a device by providing an information related to exclusion.
Method and apparatus to define TDMA time slots for Msg1 transmission via random access.
Method and apparatus for a device to determine a random access round from a number of rounds and a random access resource from a number of resources.
Method and apparatus for a device to monitor PRDCH providing Msg2 following Msg1 transmission, when a PRDCH for Msg2 transmission corresponds to a A-IoT Msg1 received from one device or when a PRDCH for Msg2 transmission corresponds to multiple A-IoT Msg1 received from different devices.
Method and apparatus for a device to receive PRDCH providing Msg2 when a PRDCH for Msg2 transmission corresponds to multiple A-IoT Msg1 received from different devices.
Method and apparatus for a device to transmit PDRCH providing Msg3 following a Msg2 reception, wherein the Msg3 is transmitted in a TDMA/FDMA manner.

The paging message includes device ID for target device identification and information related to determine the resources to be used for the following message 1 transmission. As an example, the paging message can include one or more of:
Inventory procedure type, e.g., whether it is a full-step procedure or a reduced procedure such as four-step or two-step.
   For the 4-step random access, whether the message 4 is expected or not.
Reader ID which can be uniquely identify the reader, e.g., a reader device ID, a random number, or a Cell ID.
Reader device type, whether it is a gNB based reader or a UE based reader.
An ID for identifying the legitimate paging message such as an operator ID, e.g., to distinguish a reader from an operator from another reader from another operator.
Parameters related to power control: transmission power of a message 1 preamble or any pathloss reference signal, target reception power, pathloss scaling factor, a power ramping step in dB for re-attempts.
Parameters related to random access resource configuration
   A number of time slots for random access, whose duration is predefined in the specifications of system operation or indicated in the triggering message.
   A frequency domain resources. In one example, it can be a number of frequency domain resources, wherein the resource can be a sub-carrier, a PRB, a unit frequency amount, or frequency ranges. As an example, a device may randomly select a frequency resource from the number of resources. In another example, it can be a number of frequency shifts, wherein the shifts can be indicated by ±4 Hz, ±integer multiples of a unit amount of a frequency, or a parameter of a line code, such as a number of subcarrier cycles per symbol.
   There may be an indication of available or prohibited time slots/frequency resources/shifts for random access, e.g., using a mask or a bitmap of a size equal to the number of time slots. The mask/bitmap may be provided separately for each frequency resource/shift, or commonly.
Preamble sequence: If more than one preamble pattern is supported, it can indicate information related to preamble sequence that can be used for PDRCH for the message 1 transmission. The indication may include a dedicated root sequence index for the preamble. The indication may include one or more dedicated preamble index(es). In one example, preamble indexes are indicated for respective devices addressed by the paging message.
Parameters related to random access
   Medium access probability, which may be applied for the given time slots, or per time slot in an individual manner. In one example, the access probability may be 1.
Parameters related to identifier to include in PDRCH transmission. In one example, parameters are related to random number generation such as an interval to draw a random number, e.g., [0, 2^{N}−1], wherein N is indicated. In another example, indication is provided for a type of identifier, such as device product code, e.g., PC, XPC, EPC, or a random number, and such as full format or a shortened format. In one example, more than one N values are indicated, one for a certain device group and another one for another device group. In this manner, a prioritized device identification can be performed by a device group indicated a smaller value of N.
Parameters related to PDRCH
   Transmission duration, e.g., in number of symbols or chips, payload size
   Frequency resources such as a particular sub-carrier, PRB, or frequency range for transmission. In another example, a particular frequency shift amount for UL transmission such as by ±Δ Hz, ±integer multiples of a unit amount of a frequency, or a parameter of a line code, such as a number of subcarrier cycles per symbol.
   MCS or a parameter of a line code, such as a number of subcarrier cycles per symbol.
   Attachment of preamble, midamble, postamble, and their format, e.g., long or short format, if more than one formats are supported.
   Attachment of CRC, and/or CRC size.
   Modulation type such as OOK-1, OOK-4, BPSK, QPSK, FSK, ASK with orders.
   Coding type such as indicator for Manchester coding, FM0, or Miller coding.
Parameters related to device selection
   A particular device ID, or a list of device IDs.
   A particular device group ID
      A device may be assigned with a unique device group ID, apart from a device ID.
      A device ID may be comprised of two parts; first part a device group ID and second part a device ID within the group. In this case, the first part of the device ID is indicated.
      mod (device ID, K)=L. In this case, K and L are indicated. In one example, L is fixed, e.g., zero, and only K is indicated.
   All devices, e.g., by indicating NULL or some predefined codepoint for addressing the target device or device groups in the PRDCH transmission. Indicating NULL implies that the message does not contain an ID.
Information to prevent duplicated response from a device
   This information is provided to exclude one or more certain devices participating the current inventory process and the random access rounds. The one or more excluded devices are those that the reader does not want to identify in the current inventory process, e.g., devices recently identified in a previous inventory process.
   In one example, a device exclusion list is provided.
      As an example, a device in the list identifies that it is not expected to transmit Msg1 in the inventory process indicated by the current paging message. When the paging message indicates a target group ID, wherein a device is a member of the group, or the paging message does not indicate any ID, i.e., addressed to devices receiving the paging message, if the device identifies its ID in the exclusion list, the device would not transmit Msg 1 in the current inventory process.
      In one example, the exclusion list includes one or more device IDs or device group IDs. The device ID can be a temporary ID used in a previous inventory process, e.g., RN16, or an assigned ID by a reader for communicating with the device, e.g., RN16, initially chosen for random access, promoted to an assigned ID, a full or partial EPC, or any form of an assigned ID from the reader. When the exclusion list includes a device group ID, any device belonging to the group would not be expected to perform random access.
      As another example, the exclusion list includes one or more device's partial IDs, or partial group IDs. Indicating partial ID is to reduce the overhead of signaling the exclusion list. As an example, when device ID or device group ID is comprised of a first part and a second part, the exclusion list provides only a first part of device or device group ID, and any device having matching first part of its ID would not be expected to perform random access. In another example, the partial device or device group ID can be first N₁ (>=1) digits/letters or last N₂ (>=1) digits/letters of the device or device group ID.
   In another example, a prohibit timer is provided.
      As an example, based on the prohibit timer, any device, which has been identified within the indicated prohibit timer duration, is not expected to participate the current inventory process.
      The timer duration can be indicated in any unit, e.g., ms, sec, a number of NR OFDM symbols, a number of NR slots, a number of a certain chip durations, e.g., minimum or maximum chip length supported in the system, etc.
   In yet another example, a 1-bit indication is provided such that any device, which has been identified in the previous inventory process or in the previous N inventory rounds, is not expected to participate the current inventory process.
      N may be predefined in a specification of a system operation or indicated to the device. If N is indicated to the device, instead of 1-bit indication, log 2 (N) bit indication is used. As an example, for 2-bit indication: 00 (no exclusion), 01 (N=1), 10 (N=2), 11 (N=3).
   In yet another example, a 1-bit indication is provided such that any device, whose inventoried status flag is checked, is not expected to participate the current inventory process.
      In this example, it is expected that devices maintain inventoried status flag, which is checked when the device is successfully inventoried.
      In one example, the device is expected to maintain the inventoried status flag at least for a certain timer duration, once checked. The timer duration may be predefined in a specification of a system operation or indicated to the device. In another example, the device is expected to maintain the inventoried status flag as long as its memory can be kept.
      The inventoried status flag may be released, i.e., unchecked, after a certain timer duration, when the device's battery level goes below a certain level or the device is turned off, when a device failed an inventory process, or when there is an indication to the device. As an example, a reader may provide an indication to one or more devices, with the corresponding one or more device IDs or device group IDs, or all the anonymous devices in the proximity, by not indicating any device ID, to reset the inventoried status flag.
   In yet another example, a 1-bit indication is provided such that any device, whose energy level is below a certain threshold, is not expected to participate the current inventory process.
      In one example, the energy threshold level is predefined in a specification of a system operation, indicated to the device, or determined by a device itself.
      When the energy threshold level is indicated to the device, instead of 1-bit indication, a set of threshold values are predefined, and an index from the set of threshold values can be indicated to the device.
   Any combination of the example methods herein.
Other parameters
   Maximum number of allowed random access transmissions
   Response monitoring window after transmitting the random access
   Prohibit timer after a failed random access attempt
   Allowance of UL power amplification
   System/channel/occupied BW
   Sub-carrier spacing
   Parameters related to the carrier wave (CW), e.g., CW bandwidth, frequency, single-tone or multi-tone. PRDCH to CW power offset.

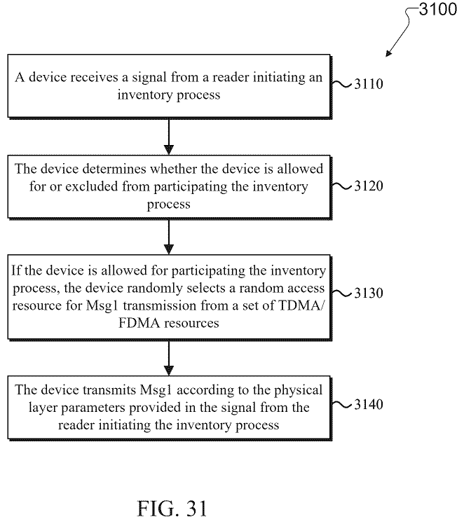

FIG. 31 illustrates a flowchart of an example device procedure 3100 for transmitting a PDRCH according to embodiments of the present disclosure. For example, procedure 3100 can be performed by any of the devices described herein. This example is for illustration only and other embodiments can be used without departing from the scope of the present disclosure.

The procedure begins in 3110, a device receives a signal from a reader initiating an inventory process. In 3120, the device determines whether the device is allowed for or excluded from participating the inventory process. In 3130, if the device is allowed for participating the inventory process, the device randomly selects a random access resource for Msg1 transmission from a set of TDMA/FDMA resources. In 3140, the device transmits Msg1 according to the physical layer parameters provided in the signal from the reader initiating the inventory process.

With reference to FIG. 31, an example flowchart is shown for a device to transmit PDRCH providing Msg1 according to the disclosure.

For TDMA, a number of time slots in the time domain can be defined in the following manner.
A number of consecutive time slots, Nₛₗₒₜ, is indicated in the paging message or in each triggering message. If it is indicated in the triggering message, different triggering messages, corresponding to a paging message, may indicate different Nₛₗₒₜ values. Alternatively, Nₛₗₒₜ may be predefined in a specification of a system operation.
The first time slot starts Tₛₜₐᵣₜ after the reception of a triggering message. If there is no separate triggering message transmitted, the first time slot starts Tₛₜₐᵣₜ after the reception of a paging message. Tₛₜₐᵣₜ can be predefined in a specification of a system operation or indicated in paging or triggering message. If Tₛₜₐᵣₜ is indicated in the triggering message, different triggering messages, corresponding to a paging message, may indicate different Tₛₜₐᵣₜ values.
The length of a time slot, Tₛₗₒₜ, can be predefined in a specification of a system operation or indicated in a paging or a triggering message.
   In one example, the physical layer parameters for transmitting Msg1, such as the message size, OOK chip rate for a given line encoding scheme, or any other physical layer parameters for transmission, are fixed in a specification of a system operation. In another example, the physical layer parameters for transmitting Msg1 are indicated to the device in a paging or a triggering message. Consequently, either predefined or indicated, the Msg1 transmission has a fixed duration from different devices and the Tₛₗₒₜ is set to accommodate the Msg1 transmission duration, e.g., the same or larger than the Msg1 transmission duration for guard time.
   The length of a time slot, Tₛₗₒₜ, may be dependent on the time slot index. Denote by Tₛₗₒₜ (k) the length of k-th time slot. In one example, Tₛₗₒₜ (k) increases with value k. Tₛₗₒₜ (k) for k=1, . . . , Nₛₗₒₜ is predefined in a specification or indicated to the devices in a paging or triggering message. The k-th slot starts Tₛₗₒₜ (1)+Tₛₗₒₜ (2)+ . . . +Tₛₗₒₜ (k−1) time after the start of the first slot, i.e., k=1.
   In another example, Tₛₗₒₜ (k) is increased by Δ for every increment of k. Tₛₗₒₜ (1) and Δ values may be predefined in a specification or indicated to the devices in a paging or triggering message. Then, for a given value of k, the device assumes Tₛₗₒₜ (k)=Tₛₗₒₜ (1)+Δ·(k−1). The k-th slot starts Tₛₗₒₜ (1)+Tₛₗₒₜ (2)+ . . . +Tₛₗₒₜ (k−1) time after the start of the first slot, i.e., k=1.
   In yet another example, Tₛₗₒₜ value is predefined or indicated to the device and it is constant with time slot index k. Instead, there is a guard time defined between k-th time slot and the following (k+1)-th time slot, denoted by T_{GT} (k), which increases with the value k. In one example, T_{GT} (k)=Δ·k, where Δ increment may be predefined or indicated in the paging/triggering message. The k-th slot starts Tₛₗₒₜ·(k−1)+T_{GT} (1)+ . . . +T_{GT} (k−1) time after the start of the first slot, i.e., k=1.

The random access from multiple devices occurs in a burst manner over a number of consecutive time slots. In one example, the length of each time slot includes D2R transmission duration for random access and guard time. In another example, the length of each time slot is equal to D2R transmission duration for random access, and there is a separate guard time provided between time slots. In yet another example, the reader transmits a certain timing reference signal, e.g., preamble, synchronization signal, etc., in the beginning of each time slot, and the D2R transmission for random access follows after a certain time interval, e.g., [T_{R2D_min}, T_{R2D_max}].

In one example, one or multiple time instances are indicated in the paging message or in the trigger message. The interval between two consecutive time instances may be fixed. In this example, a number of time instances are indicated to the devices. The start of the first time instance may be indicated or predefined in the specifications of the system operation, e.g., T_{R2D_min} or T_{R2D_max} from the triggering or paging message reception. In another example, the interval between two consecutive time instances are not fixed. For instance, the time interval increases for time instances later in time. This increased interval is to accommodate a timing drift of a device from the reception of a paging or a trigger message.

For the one or multiple indicated time instances, a device attempts to transmit at the indicated time instances according to the random decision for accessing. In another example, for the one or multiple indicated time instances, a device attempts to transmit within a certain margin, e.g., [−Δ₁, Δ₂] wherein Δ₁ and Δ₂ can be the same or different, at the indicated time instances according to the random decision for accessing. In yet another example, for the one or multiple indicated time instances, a device attempts to transmit within a certain time interval, e.g., [Δₓ, Δₓ] wherein Δₓ and Δ_{y} can be T_{R2D_min} and T_{R2D_max} as an example, from the indicated time instances according to the random decision for accessing.

For a given one or more random access rounds and for a given one or more random access resources in time/frequency domain in a given random access round, a device determines an occasion for Msg1 transmission in one of the following manner.
Method A
   A device first selects a random access round n from total N random access rounds. The total round count N can be predefined, or indicated in a paging and/or triggering message. A device may randomly select 1 random access round from N rounds, with equal probability. Alternatively, there is an access probability P_{A}, and for each random access round, a device randomly determines with probability P_{A} whether to access in the current round or not.
   Assumes that there are total M random access resources, defined in time and frequency domain, in a given random access round. This M value may be predefined or indicated in a paging and/or triggering message. The M value may be constant across random access rounds or it can vary if each triggering message indicates different M values. If a device determines to access in a given random access round, the device randomly selects 1 resource from M random access resources.
   RN-16 is separately drawn, apart from the access determination procedure herein, and included in the Msg1 as a temporary device ID.
Method B
   A device first draws a random number RN with size L, which corresponds to one random access rounds from N random access rounds, e.g., 2^{L}=N.
   The device then draws a random number RN with size (16-L), which corresponds to one random access resource in time and frequency domain in a given random access round, e.g., there are 2^{(16-L)} random access resources in a given random access round. Alternatively, the device draws a random number RN with size (16-L), which is unrelated to the random access resource selection, where a device randomly selects one resource from a set of M random access resources in a given round.
   The device then transmits at a chosen random access resource at a chosen random access round and transmits Msg1 including a RN as a temporary device ID by concatenating the first and the second RNs, i.e., RN-L and RN-(16-L).

In one example, the message 2 is provided individually for each successfully received message 1 in a burst manner. When one or more message 2 are transmitted in a burst manner, there may be a time gap, e.g., T_{R2D_R2D}, between the transmissions. Alternatively, there may be no time gap between the consecutive ACK transmissions. In another example, a group message is provided for a number of successfully received message 1 from the preceding one or more random access slots. The group message includes a number of message 2s in one transmission for one or multiple devices who message 1 transmission is successfully received at the reader.

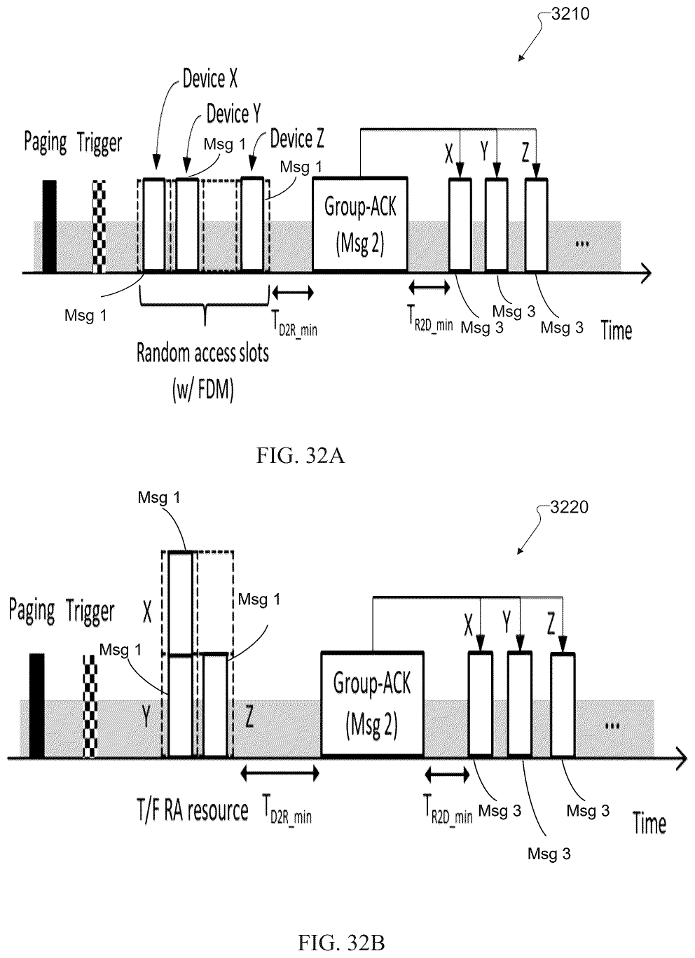

FIGS. 32A and 32B illustrate timelines 3210 and 3220 of example Msg 2 group-ACK transmissions according to embodiments of the present disclosure. For example, timelines 3210 and 3220 can be followed by any of the readers described herein and any of the devices described herein. This example is for illustration only and other embodiments can be used without departing from the scope of the present disclosure.

With reference to FIG. 32, an example Msg 2 group-ACK transmission corresponding to multiple Msg Is according to the disclosure is shown. The illustrated random access slots need not be consecutive. They can be disjoint and further associated with respective triggers. Although the figure is illustrated for the purpose of illustration providing 3-step random access. However, it is noted that any embodiment disclosed herein can be applicable for 2-step random access or 4-step random access.

When a PRDCH for Msg2 transmission corresponds to multiple A-IoT Msg1 received from different devices, the monitoring window for Msg2 can be defined as [T₁, T₂] from the end of the time domain resource for Msg1 transmission. T₁, T₂ may be predefined or indicated in the paging/triggering message. In one example, T₁, T₂ corresponds to T_{D2R_min}, T_{D2R_max}, respectively.

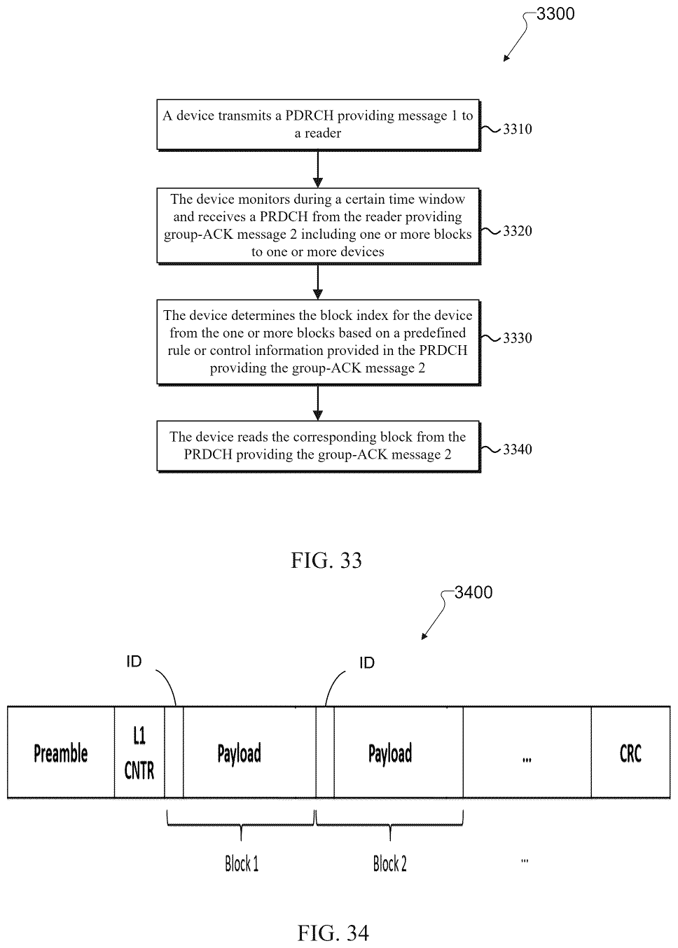

FIG. 33 illustrates a flowchart of an example device procedure 3300 for receiving a PRDCH according to embodiments of the present disclosure. For example, procedure 3300 can be performed by any of the devices described herein. This example is for illustration only and other embodiments can be used without departing from the scope of the present disclosure.

The procedure begins in 3310, a device transmits a PDRCH providing message 1 to a reader. In 3320, the device monitors during a certain time window and receives a PRDCH from the reader providing group-ACK message 2 including one or more blocks to one or more devices. In 3330, the device determines the block index for the device from the one or more blocks based on a predefined rule or control information provided in the PRDCH providing the group-ACK message 2. In 3340, the device reads the corresponding block from the PRDCH providing the group-ACK message 2.

With reference to FIG. 33, an example flowchart is shown for a device to receive a PRDCH providing group-ACK (Msg 2) according to the disclosure.

In one example, a device expects to receive a group-ACK (Msg 2) after a certain time gap from the end of the random access slots, i.e., from the end of the last slot as illustrated in the figure. The time gap may be predefined in the specifications of a system operation or indicated to the device. In one example, the time gap is T_{D2R_min}.

In another example, there is a monitoring window defined such that a device monitors a possible group-ACK for a time interval of [T₁, T₂] from the end of the last random access slot. The parameters T₁, T₂ may be predefined in the specifications of a system operation or indicated to the device in the paging or a trigger message. In one example, T₁, T₂ corresponds to T_{D2R_min}, T_{D2R_max}, respectively.

FIG. 34 illustrates an example PRDCH 3400 according to embodiments of the present disclosure. For example, PRDCH 3400 can be received by any of the devices described herein. This example is for illustration only and other embodiments can be used without departing from the scope of the present disclosure.

With reference to FIG. 34, an example PRDCH providing a group-ACK (Msg 2) according to the disclosure is shown.

In the PRDCH providing a group-ACK (Msg 2), an acknowledgement to one or more Msg 1 transmissions from one or more devices are provided.

The L1 control field provides layer 1 control information providing information related to decode the PRDCH, if present. In one example, there is no separate field for L1 control and the information related to decode the PRDCH is provided in the payload as a higher layer signaling.

In one example, the PRDCH includes a number of blocks wherein each block starts with an L1 control field indicating a device ID, e.g., RN16 echoed from Msg1, followed by payload field providing data, e.g., scheduling information for Msg3 transmission. In another example, each block is comprised of payload field, wherein both the device ID and the data are provided in the payload field, i.e., the device ID is provided as a higher-layer signaling. Each block, either for both L1 control and payload fields or just payload field, is protected by a separate CRC. Furthermore, the multiple blocks in the PRDCH can be protected by a single CRC, with or without separate CRC for each block.

In yet another example, the PRDCH provides a set of device IDs and a set of data, each corresponding to a device ID in one-to-one manner, in one payload field. In one example, the mapping of data to payload field is (ID₁, Data₁), (ID₂, Data₂), . . . , (ID_{L}, Data_{L}). In yet another example, the mapping of data to payload field is (ID₁, ID₂, . . . , ID_{L}), (Data₁, Data₂, . . . , Data_{L}) with one-to-one correspondence between ID and Data based on their position within the set of IDs and within the set of Data.

Any device determines the location of a block for the device in the PRDCH providing a group-ACK (Msg 2) in one of the following manner:
There is a fixed association between the random access resource and the location of the block in the PRDCH providing a group-ACK (Msg 2). In one example, the length of each block is fixed and predefined in a specification of a system operation. Therefore, by having the block index a device can locate the starting position of the corresponding block within the PRDCH providing a group-ACK (Msg 2).
   If the random access resource is comprised of a number of time slots, K, as illustrated in the figure, for a device transmitted Msg 1 in the k-th slot has a block index k in the PRDCH providing a group-ACK (Msg 2).
   If the random access resource is comprised of a number of frequency resources/shifts, J, for a single transmission occasion, for a device transmitted Msg 1 in the j-th frequency resource/shift has a block index j in the PRDCH providing a group-ACK (Msg 2).
   If the random access resource is comprised of a number of time slots, K, and a number of frequency resources/shifts, J, for a device transmitted Msg 1 in the k-th slot and in the j-th frequency resource/shift has a block index (k−1)·J+j. This is just an example and similar approaches should be regarded as a variant of this method.
      As one variant, there can be a notion of subgrouping of the blocks such that every J blocks are grouped into one level. Therefore, the block index for the example herein is given by (k, j).
   There may be additional resource domain, such as code domain. The same principle as described herein applies in a similar manner.
A block index for a device is provided in the PRDCH providing a group-ACK (Msg 2).
   In one example, the control information in the PRDCH provides a list of random IDs successfully received in the message 1 receptions. An index of a random ID of the device from the list of random IDs provided in the control information corresponds to the block index for the device to locate its block in the PRDCH providing a group-ACK (Msg 2). For instance, if the random ID used by the device is found in the n-th entry from the list of random IDs provided in the control information, then the block index for the device is n.
   In another example, as illustrated in the figure, each block provides an header providing the address field, where the address field provides the random ID received in the Msg 1 reception. A device searches through the blocks to find a matching random ID in the addressed field that it used for the Msg 1 transmission, which is the block for the device.

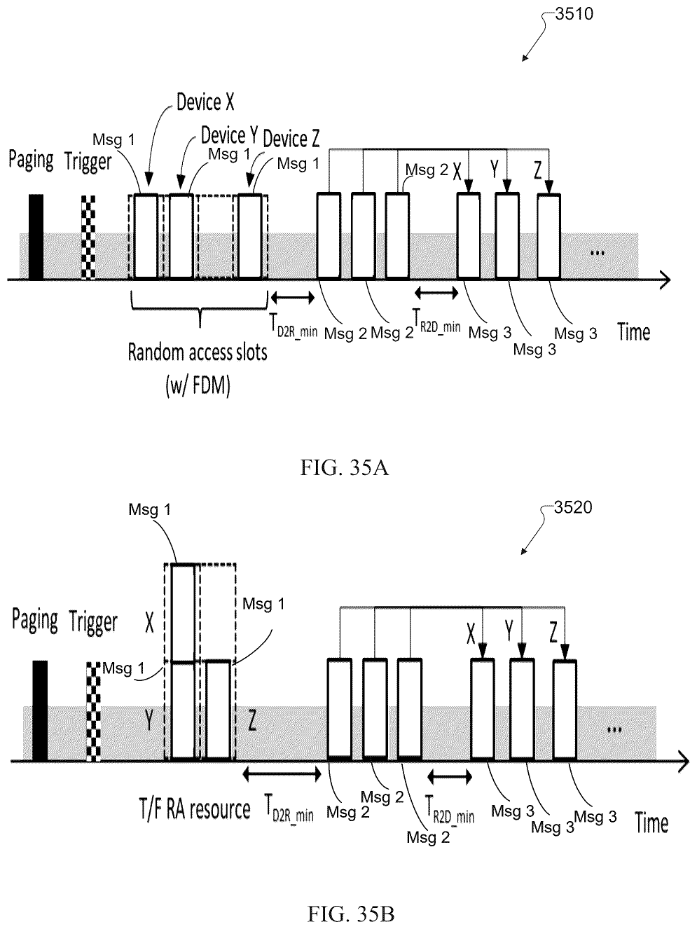

FIGS. 35A and 35B illustrate timelines of example burst Msg 2 transmissions 3510 and 3520 according to embodiments of the present disclosure. For example, burst Msg 2 transmissions 3510 and 3520 can be followed by any of the readers described herein and any of the devices described herein. This example is for illustration only and other embodiments can be used without departing from the scope of the present disclosure.

With reference to FIG. 35, an example burst Msg 2 transmissions corresponding to multiple Msg Is according to the disclosure is shown. The illustrated random access slots need not be consecutive. They can be disjoint and further associated with respective triggers. Although the figure is illustrated for the purpose of illustration providing 3-step random access. However, it is noted that any embodiment disclosed herein can be applicable for 2-step random access or 4-step random access.

When a PRDCH for Msg2 transmission corresponds to a A-IoT Msg1 received from one device, there is a monitoring window defined such that the devices, which transmitted Msg1, monitors a possible Msg2 reception intended to the device from a burst of Msg2 transmissions in a time interval [T₁, T₂] from the end of the last random access slot.
In one example, T₁, T₂ corresponds to T_{D2R_min}, T_{D2R_max}, respectively.
In another example, T₁, T₂ are indicated to the devices in a paging or a triggering messages.
In yet another example, T₁, T₂, or both T₁ and T₂ are dependent on the total number of time and frequency resources configured for the random access. For instance, it is predefined such that T₁ corresponds to T_{D2R_min}, while T₂ is determined based on the total number of random access opportunities configured in time and frequency. In principle, T₂ increases with the total number of random access opportunities within a given random access round.

When a PRDCH for Msg2 transmission corresponds to a A-IoT Msg1 received from one device, in another example, each random access time slot is associated with a separate monitoring window, which may or may not overlap with each other. Any parameters related to characterize the monitoring window, such as start and duration, can be predefined in a specification of a system operation or indicated to the devices in a paging or triggering message.
Each random access resource i, in time/frequency domain, is associated a monitoring window, [T_{i,1}, T_{i,2}] from the end of the last random access slot or from the end of the corresponding time slot wherein the i-th resource belongs. In the case of TDMA/FDMA based Msg1 transmission in the figure herein, the first and the second frequency domain resources, wherein device X and device Y transmitted their respective Msg1, belong to the first time slot and the resource wherein device Z transmitted its Msg1 belongs to the second time slot. The resource indexing i can be done in time domain first and then frequency domain, or vice versa. In other words, the monitoring window is associated with the random access resource index i, wherein the Msg1 is transmitted.
In one example, the frequency domain resources for Msg1 transmission belonging to the same time slot index share the same monitoring windows. For instance, if i=1, 2 are two frequency domain resources belonging to the same time domain index k, as exemplified in the figure herein, then both resources share the same Msg2 monitoring window given as [T_{k,1}, T_{k,2}]. In other words, the monitoring window is associated with the time slot index k, wherein the Msg1 is transmitted.
In one example, the length of the monitoring window can be dependent on the number of frequency resources/shifts configured for each time resource. For instance, for random access resource i, T_{i,2}-T_{i,1} increases with the number of frequency resources/shifts. For instance, for random access time slot k, T_{k,2}-T_{k,1} increases with the number of frequency resources/shifts.
As an example, the monitoring window associated with the first random access time slot is defined from the end of the last random access time slot as [T_{offset}, T_{offset}+W], where T_{offset} is the start offset from the end of the last random access time slot, which may be T_{D2R_min} or any other value, which may be predefined or indicated, and W is the monitoring window length, which may be predefined or indicated. Then, the monitoring window associated with the n-th random access resource, or n-th random access time slot wherein there can be more than one frequency domain resources corresponding to the n-th slot, the monitoring window is defined from the end of the last random access time slot as [T_{offset}+ (n−1)·Δ, T_{offset}+(n−1)·Δ+W], where Δ and W may be the same or different. In other words, the monitoring window is shifted by Δ time offset in every random access resource in time/frequency domain or in every random access time slot, which may be common for more than one frequency domain resources belonging to the same time slot index.
When more than one frequency resources/shifts are configured for a given time domain resource, which can be one or multiple, each frequency resource/shift may be associated with a certain offset from the start of the monitor window associated with the given random access time slot. For instance, if the monitoring window for a random access time slot k is given as [T_{k,1}, T_{k,2}], the monitoring window for the first frequency resource/shift is [T_{k,1}, T_{k,2}], for the second frequency resource/shift, it is given as [T_{k,1}+δ, T_{k,2}+δ], and for the third frequency resource/shift, it is given as [T_{k,1}+2δ, T_{k,2}+2δ] and so on. In one example, δ is equal to T_{k,2}-T_{k,1}.

In FIG. 34, a PRDCH provides a single Msg 2 which corresponds to a single Msg 1 reception in a burst manner. Any details disclosed for the group-ACK can be also applicable for the burst ACK transmission.

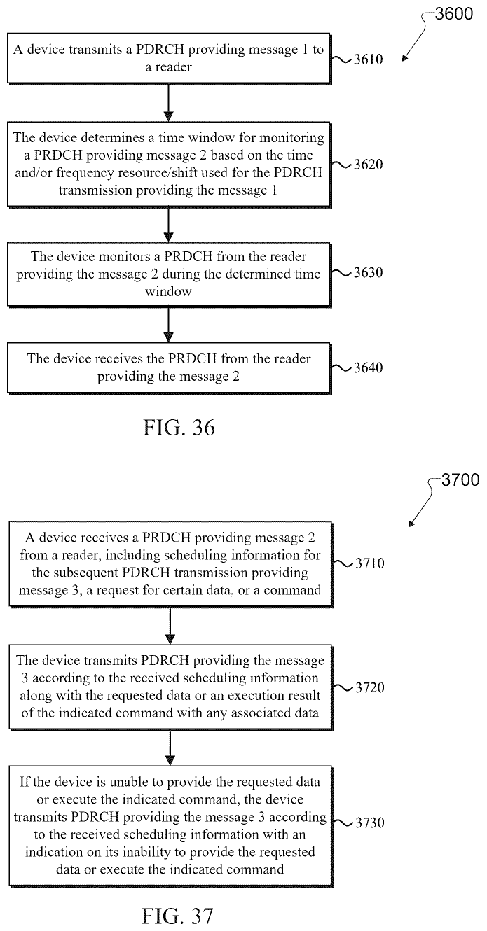

FIG. 36 illustrates a flowchart of an example device procedure 3600 for receiving a PRDCH according to embodiments of the present disclosure. For example, procedure 3600 can be performed by any of the devices described herein. This example is for illustration only and other embodiments can be used without departing from the scope of the present disclosure.

The procedure begins in 3610, a device transmits a PDRCH providing message 1 to a reader. In 3620, the device determines a time window for monitoring a PRDCH providing message 2 based on the time and/or frequency resource/shift used for the PDRCH transmission providing the message 1. In 3630, the device monitors a PRDCH from the reader providing the message 2 during the determined time window. In 3640, the device receives the PRDCH from the reader providing the message 2.

With reference to FIG. 36, an example flowchart is shown for a device to receive a PRDCH providing message 2 according to the disclosure.

A device monitors the PRDCH providing Msg 2 in one of the following example manners:
There is a monitoring window defined such that the device, who transmitted Msg 1, monitors a possible Msg 2 intended to the device from the burst Msg 2 transmissions in a time interval [T₁, T₂] from the end of the last random access slot.
   In one example, T₁, T₂ corresponds to T_{D2R_min}, T_{D2R_max}, respectively.
   In another example, T₁, T₂, or both T₁ and T₂ are dependent on the total number of time and frequency resources configured for the random access. For instance, it is predefined such that T₁ corresponds to T_{D2R_min}, while T₂ is determined based on the total number of random access opportunities configured in time and frequency. In principle, T₂ increases with the total number of random access opportunities.
In another example, each random access time slot is associated with a separate monitoring window, which may or may not overlap with each other.
   Each random access time slot i is associated a monitoring window, [T_{i,1}, T_{i,2}] from the end of the last random access slot or from the end of time slot i.
   The length of the monitoring window can be dependent on the number of frequency resources/shifts configured for each time resource. For instance, T_{i,2}-T_{i,1} increases with the number of frequency resources/shifts.
   As an example, the monitoring window associated with the first random access time slot is defined from the end of the last random access time slot as [T_{offset}, T_{offset}+W], where T_{offset} is the start offset from the end of the last random access time slot, which may be T_{D2R_min} and W is the monitoring window length. Then, the monitoring window associated with the n-th random access time slot is defined from the end of the last random access times slot as [T_{offset}+ (n−1)·Δ, T_{offset}+ (n−1)·Δ+W], where Δ and W may be the same or different.
   When more than one frequency resources/shifts are configured for a given time domain resource, which can be one or multiple, each frequency resource/shift may be associated with a certain offset from the start of the monitor window associated with the given random access time slot. For instance, if the monitoring window for the given random access time slot is given as [T₁, T₂], the monitoring window for the first frequency resource/shift is given the same as [T₁, T₂], while for the second frequency resource/shift, it is given as [T₁+δ, T₂+δ] and so on. In one example, δ is equal to T₂−T₁.

Any of the described parameters herein may be predefined in the specifications of a system operation or indicated to the device in the paging or a trigger message.

FIG. 37 illustrates a flowchart of an example device procedure 3700 for receiving a PRDCH and transmitting a PRDCH according to embodiments of the present disclosure. For example, procedure 3700 can be performed by any of the devices described herein. This example is for illustration only and other embodiments can be used without departing from the scope of the present disclosure.

The procedure begins in 3710, a device receives a PRDCH providing message 2 from a reader, including scheduling information for the subsequent PDRCH transmission providing message 3, a request for certain data, or a command. In 3720, the device transmits PDRCH providing the message 3 according to the received scheduling information along with the requested data or an execution result of the indicated command with any associated data. In 3730, if the device is unable to provide the requested data or execute the indicated command, the device transmits PDRCH providing the message 3 according to the received scheduling information with an indication on its inability to provide the requested data or execute the indicated command.

With reference to FIG. 37, an example flowchart is shown for a device to receive a PRDCH providing message 2 and transmit a PDRCH providing a message 3 according to the disclosure.

Each block of a PRDCH providing a group-ACK (Msg 2), a PRDCH providing a single ACK (Msg 2) from a burst of PRDCHs providing Msg2s, or a normal PRDCH providing a single ACK (Msg 2) can provide one or more of the following information:
Scheduling information for Msg 3 including PDRCH transmission timing and a frequency resource/shift, if applicable. The time unit for the timing indication can be one of the options as described later.
Any data request to be included in the Msg 3.
A command. It is an indication of an index to a certain codepoint from a set of codepoints, wherein each code point corresponds to a certain command type which is predefined in a specification of a system operation.

Also, any of the listed information herein can be provided in the Msg 2 of the 2-step random access wherein in this case the provided information is not intended for Msg 3 but for a PDRCH transmission, which is decoupled from the random access procedure.

If the Msg 2 indicates a device to provide a certain data in the Msg 3, the device includes the requested data in the Msg 3 transmission. If the device is unable to provide the request data, e.g., due to unavailability of the data, processing time shortage, or low energy level, the device indicates in the Msg 3 to the reader that it is unable to provide the requested data.

If the Msg 2 indicates a device to execute a certain command, the device includes the command execution result and associated data, if any, in the Msg 3 transmission. If the device is unable to execute the command, e.g., due to unavailability of the data, processing time shortage, or low energy level, the device indicates in the Msg 3 to the reader that it is unable to execute the requested command.

A device transmits Msg3 according to the scheduling information provided in the Msg2. The Msg3 transmission resources can be defined as a set of TDMA/FDMA resources, similar to that of random access resources for Msg1. As an example, there can be N′ₛₗₒₜ time slots for TDMA and/or N′_{freq} frequency domain resources for FDMA, i.e., a total of N′ₛₗₒₜ·N′_{freq} resources.

The frequency domain resources are defined as a set of frequency shift factors, which may be applied in the baseband. For a given frequency domain resource index n from N′_{freq} resources, the amount of frequency shift can be predefined in a specification of a system operation. Alternatively, the amount of frequency shift can be indicated in the Msg2. Alternatively, the amount of frequency shift can be indicated in a paging or triggering message.

The time domain resources for Msg3 transmission can be similarly defined as the time domain resources for Msg1 transmission. The start of the time domain resources for Msg3 can be defined from the timing of PRDCH reception providing the Msg2. In one example, the Msg3 transmission resource is indicated as an index from N′ₛₗₒₜ·N′_{freq} resources. In one example, the indexes 1, . . . , N′ₛₗₒₜ·N′_{freq} maps to time slot index first and then frequency domain index next. In another example, the indexes 1, . . . , N′ₛₗₒₜ·N′_{freq} maps to frequency domain index first and then time slot index next. In another example, the Msg3 transmission resource is indicated as a pair of indexes, one for time slot index from 1, . . . , N′ₛₗₒₜ and another one for frequency domain index from 1, . . . , N′ freq.

In another example, instead of defining TDMA/FDMA resources, the Msg2 directly provides a timing delay parameter for Msg3 transmission from the reception timing of the Msg2. In addition, the frequency shift factor for Msg3 can be indicated in the Msg2. In yet another example, the timing delay parameter is predefined in a specification of a system operation and a device assumes a fixed timing delay from the reception of Msg2 for determining the Msg3 transmission timing.

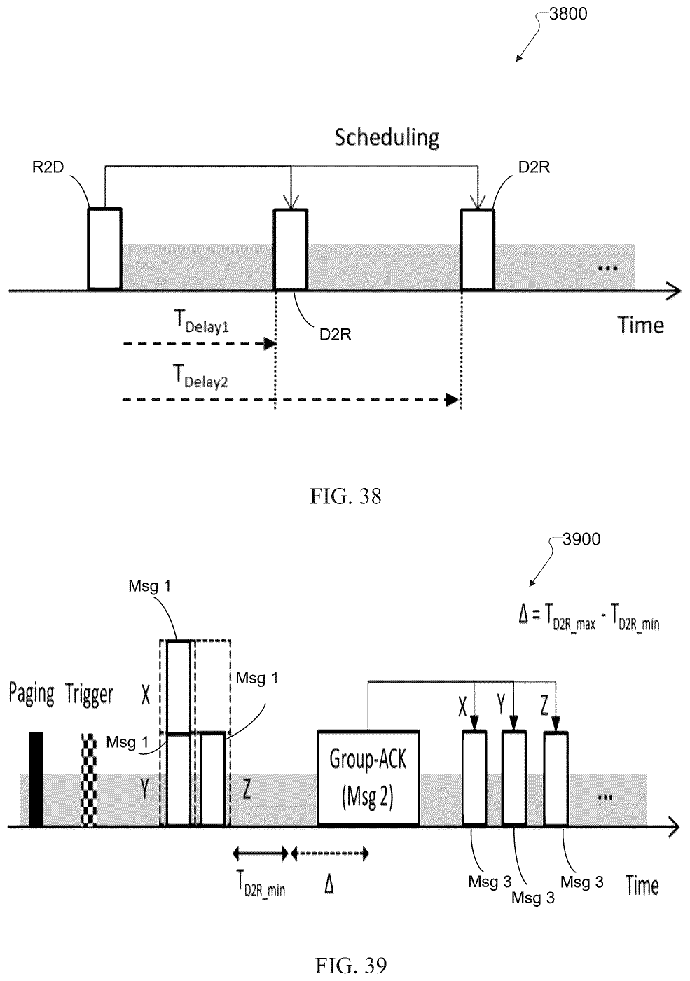

FIG. 38 illustrates a timeline 3800 for example scheduling multiple D2R transmissions according to embodiments of the present disclosure. For example, timeline 3800 can be followed by any of the readers described herein and any of the devices described herein. This example is for illustration only and other embodiments can be used without departing from the scope of the present disclosure.

For T_{R2D} timing, in one embodiment, T_{R2D_min} and T_{R2D_max} are defined such that a device is not expected to transmit D2R transmission earlier than T_{R2D_min} or later than T_{R2D_max} following the preceding R2D transmission.

In another embodiment, T_{R2D_nominal} and frequency tolerance range, e.g., in terms of percentage, are defined. The frequency tolerance may be related to device SFO drift. From a device perspective, it transmits exactly at T_{R2D_nominal} after the reception of the preceding R2D transmission, while the actual timing can drift within the tolerance range.

For T_{D2R} timing, in one embodiment, T_{D2R_min} is defined such that, from a device perspective, the device is not required to receive R2D transmission earlier than T_{D2R_min} from the reception of the preceding D2R transmission. T_{D2R_max} is defined from both a reader and a device perspectives. The provisioned timing range defined by T_{D2R_min} and T_{D2R_max} are not for reader's random selection within the range but for a reader to accommodate delays in handling a varying number of devices at a given time. From a device perspective, if R2D transmission is not received within the timing range, the device can determine the failure of the current inventory/command round and the device can restart the inventory round or send appropriate feedback for the success/failure of executing the command.

For T_{R2D_R2D}, there is a need to define T_{R2D_R2D_min} taking into account that there should be a sufficient processing time provisioned for a device to process back-to-back R2D transmissions such as a PRDCH providing a paging message followed by another PRDCH providing a triggering message, or a PRDCH providing a command followed by another PRDCH providing a command, etc.

With reference to FIG. 38, an example R2D transmission is shown scheduling one or more D2R transmissions via a timing delay indication.

Multiple D2R transmissions do not need to be in a TDMA manner with a defined notion of time slots. It can be in an asynchronous manner based on indicated timing parameters.

In one embodiment, the timing of a D2R transmission following a corresponding R2D transmission is determined based on the control information in the R2D transmission if provided, where T_{R2D}≥T_{R2D_min}. Otherwise, the device transmits D2R transmission within [T_{R2D_min}, T_{R2D_max}]. In another embodiment, the timing of a D2R transmission following a corresponding R2D transmission is determined based on the control information in the R2D transmission if provided, where T_{R2D}≥T_{R2D_max}. Otherwise, the device transmits D2R transmission within [T_{R2D_min}, T_{R2D_max}]. This is because T_{R2D_min} and T_{R2D_max} are more of a requirement for device implementation to handle the frequency tolerance rather than for device's random timing selection within the range. The device implementation will ensure that the timing drift would not exceed T_{R2D_max} but it cannot guarantee that it can meet the T_{R2D_min} timing. Therefore, in this example, the minimum of the timing delay parameter for the indication is T_{R2D_max}.

FIG. 39 illustrates a timeline 3900 of example reception timing for a Msg2 corresponding to multiple Msg 1 according to embodiments of the present disclosure. For example, timeline 3900 can be followed by any of the readers described herein and any of the devices described herein. This example is for illustration only and other embodiments can be used without departing from the scope of the present disclosure.

For Msg2 corresponding to one or more Msg1, a device starts monitoring the PRDCH providing Msg2 T_{D2R_min} after the end of X time domain resources for Msg1 transmission, wherein X is the number of time slots, which is X=2 in this example. The monitoring window Δ is such that the start of PRDCH falls within the Δ time interval after the start of monitoring, which may be predefined in a specification of a system operation or indicated to the device. In one example, Δ=T_{D2R_max}−T_{D2R_min} such that the start of PRDCH falls within the Δ time interval.

If Msg2 is not received within the A time interval, the device considers that the current inventory round is unsuccessful and restarts the inventory round, e.g., retransmit Msg1 in a later round. It is noted that the timing of the end of X time domain resources is the timing perceived by the device with the timing imperfection such as due to SFO, and it can deviate from the precise timing perceived by the reader. Given that there is no timing adjustment for a device in A-IoT, the reader accommodates such timing imperfection by accounting a certain timing margin considering timing drift by devices.

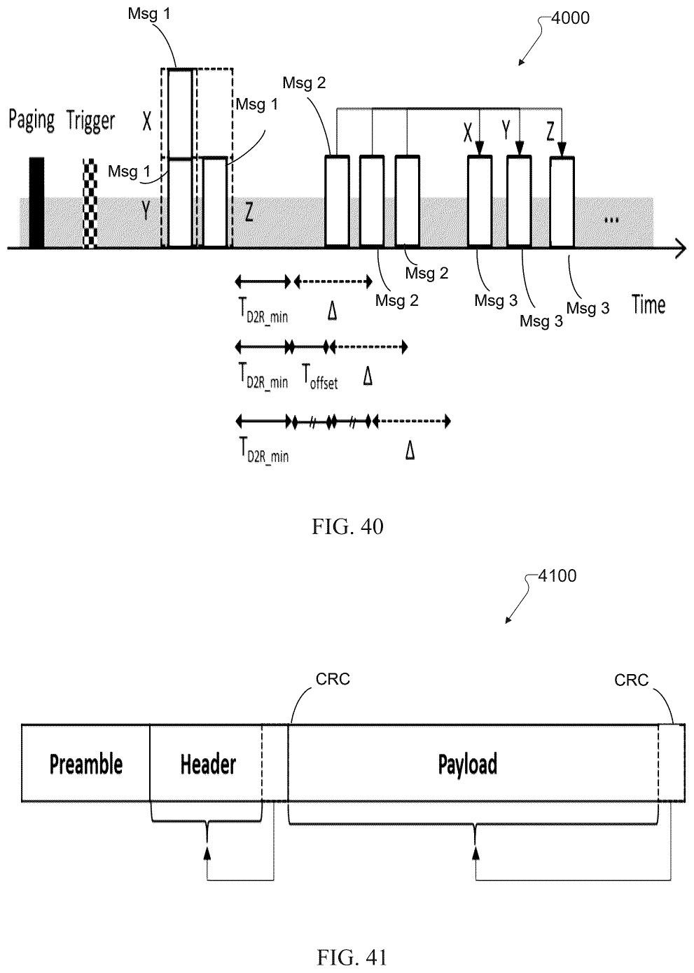

FIG. 40 illustrates a timeline 4000 of example reception timing for a Msg2 corresponding to a Msg1 according to embodiments of the present disclosure. For example, timeline 4000 can be followed by any of the readers described herein and any of the devices described herein. This example is for illustration only and other embodiments can be used without departing from the scope of the present disclosure.

For a Msg2 corresponding to a Msg1, the reference timing for a device to start monitoring the PRDCH providing Msg2 can be still the same as before, i.e., T_{D2R_min} after the end of X time domain resources for Msg1 transmission. In this case, given that more than one Msg2s can be transmitted in a staggered manner, there can be an additional offset to start monitoring the Msg2.

The time/frequency resources for Msg1 transmission are indexed by frequency, then time. As an example, in the figure herein, it can be indexed in the order of (x=1, y=1), (x=1, y=2), (x=2, y=1), (x=2, y=2) wherein x is the time slot index and y is the frequency resource index, e.g., frequency shifts. For Msg1 transmission resource index 1, there is no additional offset and the monitoring window Δ time interval starts T_{D2R_min} after the end of X time domain resources for Msg1 transmission. For Msg1 transmission resource index i, there is (i−1)×T_{offset} additional timing offset to start monitoring Δ time interval T_{D2R_min} after the end of X time domain resources for Msg1 transmission. T_{offset} can be defined to account the transmission duration of PRDCH providing single Msg2 and any additional guard time between PRDCH transmissions providing Msg2. Similarly, the indexing can be performed in time first and, then in frequency next. The same approach can be applied. T_{offset} can be predefined or indicated to the device.

FIG. 41 illustrates an example PRDCH 4100 according to embodiments of the present disclosure. For example, PRDCH 4100 can be received by any of the devices described herein. This example is for illustration only and other embodiments can be used without departing from the scope of the present disclosure

With reference to FIG. 41, PRDCH providing triggering message or Msg2 according to the disclosure is shown, while the followings are applicable for PRDCH in general.

In one embodiment, the header field provide information related to receive the PRDCH including at least one of:
ID associated with device(s) intended for the reception of R2D
TBS/payload related information, explicitly or implicitly based on message type indication with fixed size
Message type
Reader ID

In one embodiment, the header field has a fixed size, which may be predefined in a specification of a system operation. In another embodiment, the header field size is indicated to the device in another PRDCH. In one example, PRDCHs with a certain message types have a fixed size. As an example, the PRDCH providing paging message may have the header field with a fixed size. In another example, the PRDCH providing paging message may have the header field with a fixed size. In another example, the header field size of some other message types is indicated by a PRDCH with a message type having a fixed size.

In one embodiment, the header field size has a set of fixed sizes, e.g., up to 1, 2 or 3 fixed sizes, and blindly detected by the device. If there is only one fixed size, no blind detection is performed.

The header field with a fixed size is attached with CRC-6. In another example, the header field with a fixed size is attached with CRC-16. In yet another example, the header field with a fixed size is not attached with CRC.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for an Ambient Internet of Things (A-IoT) device to communicate with a reader, the method comprising:
receiving a first physical reader-to-device channel (PRDCH) providing an A-IoT paging message initiating device identification, wherein the A-IoT paging message indicates:
a total number of access occasions,
a number of time domain resources of the access occasions, and
via a bitmap, a set of allowed small frequency shift factors;
determining, based on reception of the A-IoT paging message, an access occasion from the total number of access occasions via random selection;
receiving a second PRDCH providing an access trigger message triggering a set of access occasions from the total number of access occasions;
transmitting a first physical device-to-reader channel (PDRCH) providing a random identifier (ID) message including a 16-bit random number as an ID in the determined access occasion;
receiving a third PRDCH providing a random ID response message, wherein:
the random ID response message confirms successful reception of one or more random ID messages, and
the random ID response message provides device to reader (D2R) scheduling information including information related to D2R chip length; and
transmitting a second PDRCH providing a D2R message based on reception of the third PRDCH.

2. The method of claim 1, wherein:
the first PRDCH provides both the A-IoT paging message and an access trigger message for a first set of access occasions from the total number of access occasions, and
the second PRDCH provides the access trigger message for a second set of access occasions from the total number of access occasions.

3. The method of claim 1, wherein:
the random ID response message includes a number of information blocks,
an information block from the number of information blocks corresponds to the random ID message, which was successfully received, and
the information block includes the 16-bit random number from the random ID message at a beginning of the information block, which is followed by additional information to the A-IoT device.

4. The method of claim 1, wherein:
the number of time domain resources of the access occasions is up to two,
a first time domain resource from the number of time domain resources starts after a first time offset from an end of the first PRDCH or from an end of the second PRDCH,
a second time domain resource from the number of time domain resources starts after a second time offset from the end of the first PRDCH or from the end of the second PRDCH,
the first time offset is fixed, and
the second time offset includes a transmission duration of the first PDRCH, the first time offset, and a guard time.

5. The method of claim 1, wherein the A-IoT paging message includes a transaction ID to enable the A-IoT device to distinguish a valid inventory procedure from an invalid inventory procedure.

6. The method of claim 1, wherein the random ID response message either confirms the 16-bit random number as the ID or provides a new ID different from the 16-bit random number.

7. The method of claim 1, wherein:
the first PDRCH and the second PDRCH are prepended with a preamble and include one or more midambles, and
the preamble and the one or more midambles are identical.

8. An Ambient Internet of Things (A-IoT) device, comprising:
a transceiver configured to receive a first physical reader-to-device channel (PRDCH) providing an A-IoT paging message initiating device identification, wherein the A-IoT paging message indicates:
a total number of access occasions,
a number of time domain resources of the access occasions, and
via a bitmap, a set of allowed small frequency shift factors;
processing circuitry operably coupled with the transceiver, the processing circuitry configured to determine, based on reception of the A-IoT paging message, an access occasion from the total number of access occasions via random selection,
wherein the transceiver is further configured to:
receive a second PRDCH providing an access trigger message triggering a set of access occasions from the total number of access occasions;
transmit a first physical device-to-reader channel (PDRCH) providing a random identifier (ID) message including a 16-bit random number as an ID in the determined access occasion;
receive a third PRDCH providing a random ID response message, wherein:
the random ID response message confirms successful reception of one or more random ID messages, and
the random ID response message provides device to reader (D2R) scheduling information including information related to D2R chip length; and
transmit a second PDRCH providing a D2R message based on reception of the third PRDCH.

9. The A-IoT device of claim 8, wherein:
the first PRDCH provides both the A-IoT paging message and an access trigger message for a first set of access occasions from the total number of access occasions, and
the second PRDCH provides the access trigger message for a second set of access occasions from the total number of access occasions.

10. The A-IoT device of claim 8, wherein:
the random ID response message includes a number of information blocks,
an information block from the number of information blocks corresponds to the random ID message, which was successfully received, and
the information block includes the 16-bit random number from the random ID message at a beginning of the information block, which is followed by additional information to the A-IoT device.

11. The A-IoT device of claim 8, wherein:
the number of time domain resources of the access occasions is up to two,
a first time domain resource from the number of time domain resources starts after a first time offset from an end of the first PRDCH or from an end of the second PRDCH,
a second time domain resource from the number of time domain resources starts after a second time offset from the end of the first PRDCH or from the end of the second PRDCH,
the first time offset is fixed, and
the second time offset includes a transmission duration of the first PDRCH, the first time offset, and a guard time.

12. The A-IoT device of claim 8, wherein the A-IoT paging message includes a transaction ID to enable the A-IoT device to distinguish a valid inventory procedure from an invalid inventory procedure.

13. The A-IoT device of claim 8, wherein the random ID response message either confirms the 16-bit random number as the ID or provides a new ID different from the 16-bit random number.

14. The A-IoT device of claim 8, wherein:
the first PDRCH and the second PDRCH are prepended with a preamble and include one or more midambles, and
the preamble and the one or more midambles are identical.

15. A reader, comprising:
a transceiver configured to transmit, to an Ambient Internet of Things (A-IoT) device, a first physical reader-to-device channel (PRDCH) providing an A-IoT paging message initiating device identification, wherein the A-IoT paging message indicates:
a total number of access occasions,
a number of time domain resources of the access occasions, and
via a bitmap, a set of allowed small frequency shift factors;
a processor operably coupled with the transceiver, the processor configured to determine, based on transmission of the A-IoT paging message, an access occasion from the total number of access occasions via random selection,
wherein the transceiver is further configured to:
transmit a second PRDCH providing an access trigger message triggering a set of access occasions from the total number of access occasions;
receive a first physical device-to-reader channel (PDRCH) providing a random identifier (ID) message including a 16-bit random number as an ID in the determined access occasion;
transmit a third PRDCH providing a random ID response message, wherein:
the random ID response message confirms successful reception of one or more random ID messages, and
the random ID response message provides device to reader (D2R) scheduling information including information related to D2R chip length; and
receive a second PDRCH providing a D2R message based on transmission of the third PRDCH.

16. The reader of claim 15, wherein:
the first PRDCH provides both the A-IoT paging message and an access trigger message for a first set of access occasions from the total number of access occasions, and
the second PRDCH provides the access trigger message for a second set of access occasions from the total number of access occasions.

17. The reader of claim 15, wherein:
the random ID response message includes a number of information blocks,
an information block from the number of information blocks corresponds to the random ID message, which was successfully received, and
the information block includes the 16-bit random number from the random ID message at a beginning of the information block, which is followed by additional information to the A-IoT device.

18. The reader of claim 15, wherein:
the number of time domain resources of the access occasions is up to two,
a first time domain resource from the number of time domain resources starts after a first time offset from an end of the first PRDCH or from an end of the second PRDCH,
a second time domain resource from the number of time domain resources starts after a second time offset from the end of the first PRDCH or from the end of the second PRDCH,
the first time offset is fixed, and
the second time offset includes a reception duration of the first PDRCH, the first time offset, and a guard time.

19. The reader of claim 15, wherein the A-IoT paging message includes a transaction ID to enable the A-IoT device to distinguish a valid inventory procedure from an invalid inventory procedure.

20. The reader of claim 15, wherein the random ID response message either confirms the 16-bit random number as the ID or provides a new ID different from the 16-bit random number.
